(19) United States
(12) Patent Application Publication
(10) Pub. No.: US 2021/0125227 A1
(43) Pub. Date: Apr. 29, 2021

(54) SETTING DRIVING ROUTE OF ADVERTISING AUTONOMOUS VEHICLE

(71) Applicant: LG ELECTRONICS INC, Seoul (KR)

(72) Inventors: Chulhee LEE, Seoul (KR); Namyong PARK, Seoul (KR); Dongkyu LEE, Seoul (KR); Eunkoo LEE, Seoul (KR); Taesuk YOON, Seoul (KR)

(21) Appl. No.: 16/918,038

(22) Filed: Jul. 1, 2020

(30) Foreign Application Priority Data
Oct. 29, 2019 (KR) 10-2019-0135875

(51) Int. Cl. G06Q 30/02; G05D 1/02

(52) U.S. Cl. CPC G06Q 30/0266; G05D 1/0285; G06Q 30/0246; G05D 1/0221

(57) ABSTRACT

A method of setting a driving route of an autonomous vehicle (AV) providing an advertisement on a road obtains information related to an advertisee's reaction to the advertisement, sets an order of priority for lanes in which the AV is drivable depending on a reference and based on road context information and a current lane of the AV, and determines a driving lane and driving route of the AV with a driving lane set based on the order of priority. The method determines a degree of reaction of the advertisee to the advertisement and sets the driving route and driving lane based on the advertisee's degree of reaction for efficient advertisement. The method can be associated with artificial intelligence modules, drones (unmanned aerial vehicles (UAVs)), robots, augmented reality (AR) devices, virtual reality (VR) devices, devices related to 5G service, etc.

### CROSS-REFERENCE TO RELATED APPLICATIONS

This application is based on and claims priority under 35 U.S.C. 119 to Korean Patent Application No. 10-2019-0135875, filed on Oct. 29, 2019, in the Korean Intellectual Property Office, the disclosure of which is herein incorporated by reference in its entirety.

### TECHNICAL FIELD

The disclosure relates to a method of setting a driving route of an autonomous vehicle and an apparatus for the same.

### BACKGROUND

Vehicles can be classified into an internal combustion engine vehicle, an external composition engine vehicle, a gas turbine vehicle, an electric vehicle, etc. according to types of motors used therefor.

Vigorous development efforts are underway to mobile advertisement technology based on autonomous vehicles (AVs) on the road. Navigation systems are adopted to direct AVs so as to enable efficient advertisement. However, the conventional art neglects advertisees' reactions or per-driving segment features on the road in setting a driving route for advertising AVs. Such conventional methods for setting a driving route for AVs may not meet the goal of advertising AVs.

Therefore, a need exists for considering advertisees' reactions to advertisements or features for each driving segment where AVs are to drive so as to direct AVs to a route efficient for advertisement.

### SUMMARY

The present disclosure aims to achieve the above-described needs and/or to solve the above-described problems.

In addition, an object of the present disclosure is to implement a method for setting a driving route of a vehicle.

In addition, the present specification is to implement a method for determining the responsiveness to the advertisement of the advertiser receiving the advertisement in order to provide an efficient advertisement.

In addition, the present specification aims to implement a method for setting the driving route based on the responsiveness to the advertisement of the advertiser receiving the advertisement in order to provide an efficient advertisement.

In addition, an object of the present disclosure is to implement a method for setting a driving lane of an advertisement target vehicle in order to provide an efficient advertisement.

In addition, an object of the present disclosure is to implement a method for setting a driving route of an advertisement target vehicle for providing an efficient advertisement.

The technical problems to be achieved in the present specification are not limited to the above-mentioned technical problems, and other technical problems not mentioned above are apparent to those skilled in the art from the following description.

In an aspect, a method of setting a driving route of an autonomous vehicle (AV) providing an advertisement on a road, the method comprising: obtaining information related to an advertisee's reaction to the advertisement; obtaining road context information for surroundings of a current lane in which the AV is driving; setting an order of priority for lanes in which the AV are drivable depending on a predetermined reference; and driving the AV in a lane set based on the order of priority.

Wherein the road context information may include information indicating whether there is a sidewalk, relative speed information for ambient lanes of the current lane, or information for road congestion or vehicles around the current lane.

Wherein when there is a sidewalk, a lane adjacent to the sidewalk may be set to have priority.

Wherein when there is no sidewalk, a center lane among all lanes, including the current lane, of the road on which the AV is driving may be set to have priority.

Wherein when there are two or more center lanes, a specific one with a smaller speed relative to its two adjacent lanes among the two or more center lanes may be set as the driving lane based on relative speed information for the driving lane.

Wherein when there is no sidewalk on the road and there are two or more left-turn lanes, a leftmost one of the two or more left-turn lanes may be set to have priority.

The method may further comprise: receiving driving route setting information from a network; and setting a driving route based on the driving route setting information, wherein the driving route setting information includes at least one of per-driving segment road congestion information, pedestrian count information for the number of pedestrians on a sidewalk present in the driving segment, or all-lane relative speed information related to relative speeds of all lanes per driving segment.

Wherein the reaction-related information may include a reaction value indicating a degree of reaction to the advertisee's advertisement, and wherein obtaining the reaction-related information includes determining whether there is the advertisee's gaze at the advertisement by analyzing an image captured by a camera mounted in the AV, determining whether the advertisee makes a specific gesture towards the advertisement, receiving the advertisee's voice input, and determining whether the voice input contains content related to the advertisement.

Wherein setting the driving route may include setting the driving route based on a first weight determined based on the reaction-related information, a second weight determined based on the road congestion information, and a third weight determined based on the pedestrian count information when there is the sidewalk on the road, and wherein a pedestrian on the sidewalk present in the driving segment is an advertisee.

Wherein the first weight may increase as the reaction value increases, and wherein the reaction value may be increased by a predetermined value when there is the advertisee's gaze, when there is the specific gesture, or when the voice input contains the advertisement-related content, and the reaction value is maintained when there is not the advertisee's gaze, there is not the specific gesture, or when the voice input does not contain the advertisement-related content.

Wherein the second weight may be increased as a degree of congestion increases.

Wherein the third weight may be increased as the number of advertisees increases.

Wherein setting the driving route may include setting the driving route based on a first weight determined based on the information related to the advertisee's reaction and a second weight determined based on the all-lane relative speed information when there is no sidewalk.

Wherein the second weight may be increased as an absolute value of a relative speed indicated by the all-lane relative speed information decreases.

Wherein the advertisement may be displayed on a display mounted in the AV, and wherein the advertisement displayed on the display may be changed to another advertisement in a predetermined period based on ambient information.

Wherein the predetermined period may decrease as an absolute value of a relative speed indicated by the ambient lane relative speed information decreases, and wherein the advertisement may not be displayed on the display when the ambient vehicle information indicates that there are no ambient vehicles around the current lane.

Wherein the display may be mounted on at least one of a front, back, right-side, or left-side surface of the AV, wherein the display may be split into at least one screen to simultaneously display at least one different advertisement, and wherein the number of the at least one different advertisement may be increased as the absolute value of the relative speed indicated by the ambient lane relative speed information decreases.

The method may further comprise downlink control information (DCI) used for scheduling transmission of the road context information, wherein the road context information is transmitted to the network based on the DCI.

The method may further comprise: performing an initial access procedure with the network based on a synchronization signal block (SSB), wherein the road context information is transmitted to the network via a physical uplink shared channel (PUSCH), and wherein dedicated demodulation reference signals (DM-RSs) of the SSB and the PUSCH may be quasi co-located (QCL) for QCL type D.

The method may further comprise: controlling a transceiver to transmit the road context information to an artificial intelligence (AI) processor included in the network; and controlling the transceiver to receive AI-processed information from the AI processor, wherein the AI-processed information includes the driving lane information or the driving route information.

An intelligent computing device controlling an AV may include a wireless transceiver, a sensor, a camera, a processor, and a memory including instructions executable by the processor. The instructions may enable the processor to obtain information related to an advertisee's reaction to an advertisement, obtain ambient information related to an ambient environment of a current lane where the AV is driving, set an order of priority for lanes in which the AV is drivable based on the ambient information, and drive the AV in a driving lane set based on the order of priority.

The disclosure provides a method of setting a driving route for a vehicle.

According to the present disclosure, it is possible to determine the degree of reaction to an advertisement of an advertisee receiving the advertisement to enable efficient advertisement.

According to the present disclosure, it is possible to set a driving route based on the degree of reaction to the advertisement of the advertisee receiving the advertisement to enable efficient advertisement.

According to the present disclosure, it is possible to implement a method for setting a driving lane of an adverting-purposed vehicle to enable efficient advertisement.

According to the present disclosure, it is possible to set a driving route for an advertising-purposed vehicle to enable efficient advertisement.

Effects of the present disclosure are not limited to the foregoing, and other unmentioned effects would be apparent to one of ordinary skill in the art from the following description.

### BRIEF DESCRIPTION OF THE DRAWINGS

Accompanying drawings included as a part of the detailed description for helping understand the present disclosure provide embodiments of the present disclosure and are provided to describe technical features of the present disclosure with the detailed description.

FIG. 1 is a block diagram of a wireless communication system to which methods proposed in the disclosure are applicable.

FIG. 2 shows an example of a signal transmission/reception method in a wireless communication system.

FIG. 3 shows an example of basic operations of an autonomous vehicle and a 5G network in a 5G communication system.

FIG. 4 shows an example of a basic operation between vehicles using 5G communication.

FIG. 5 illustrates a vehicle according to an embodiment of the present disclosure.

FIG. 6 is a control block diagram of the vehicle according to an embodiment of the present disclosure.

FIG. 7 is a control block diagram of an autonomous device according to an embodiment of the present disclosure.

FIG. 8 is a diagram showing a signal flow in an autonomous vehicle according to an embodiment of the present disclosure.

FIG. 11 is a diagram referred to in description of a usage scenario of a user according to an embodiment of the present disclosure.

FIG. 10 is a view illustrating an AV providing advertisements according to an embodiment of the present disclosure.

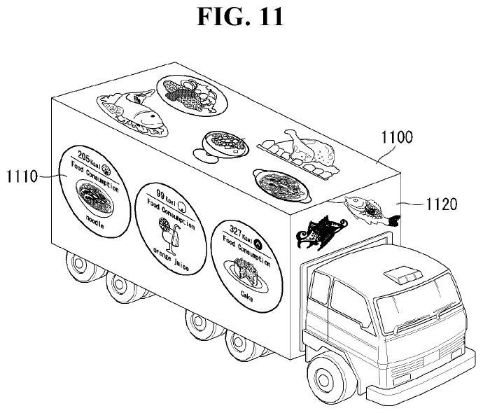

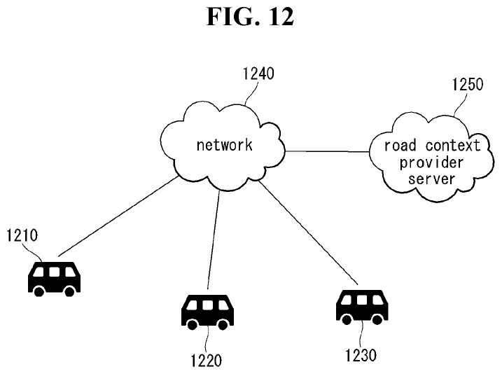

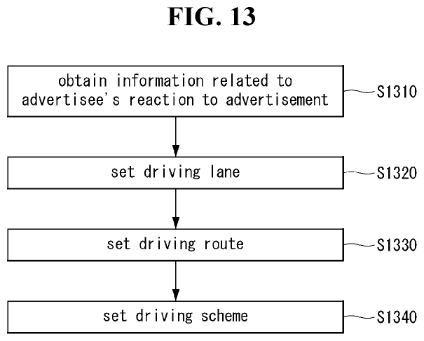

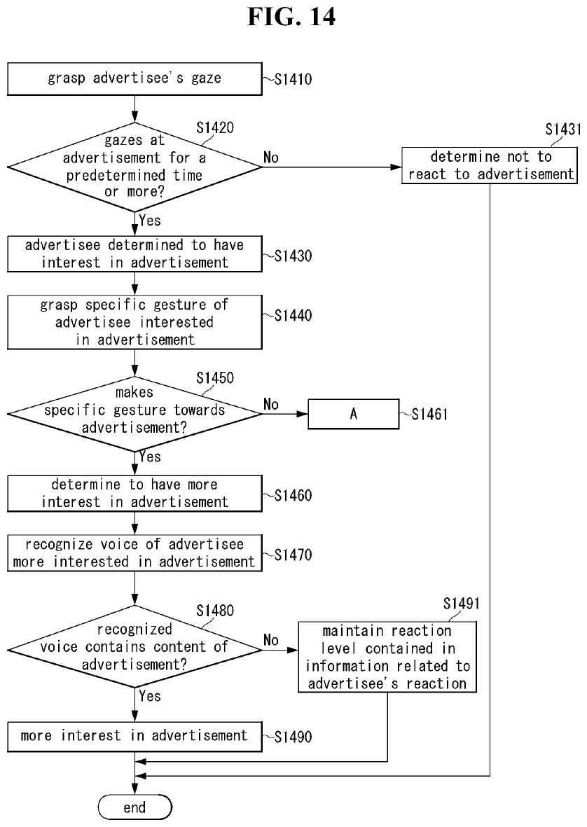

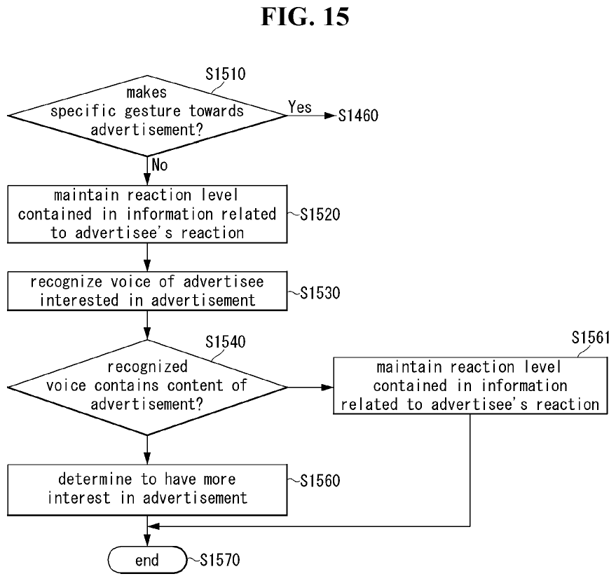

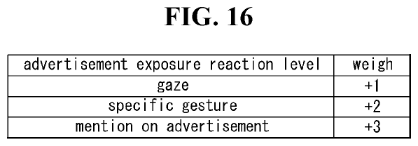

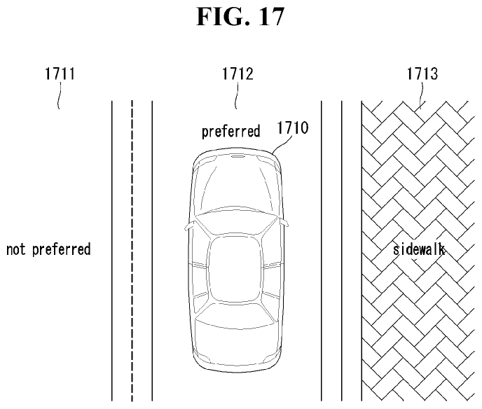

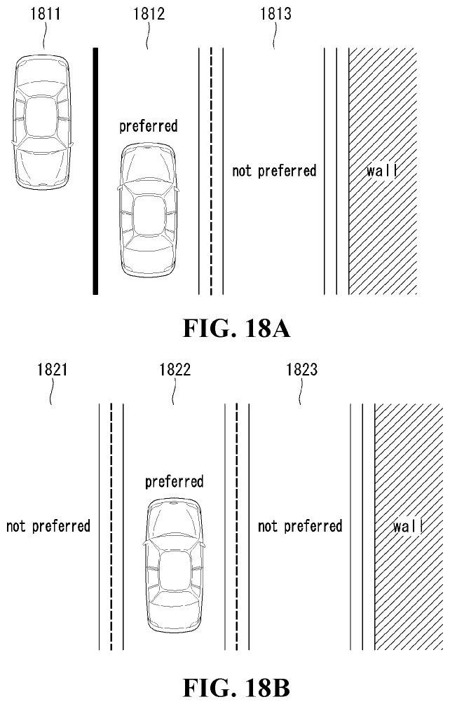

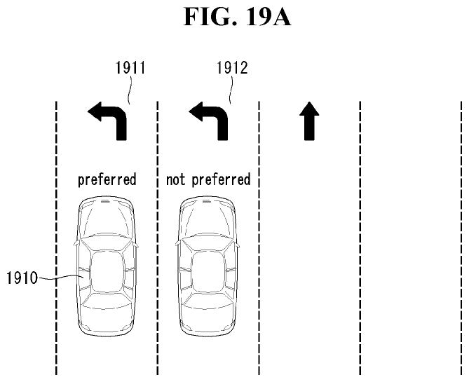

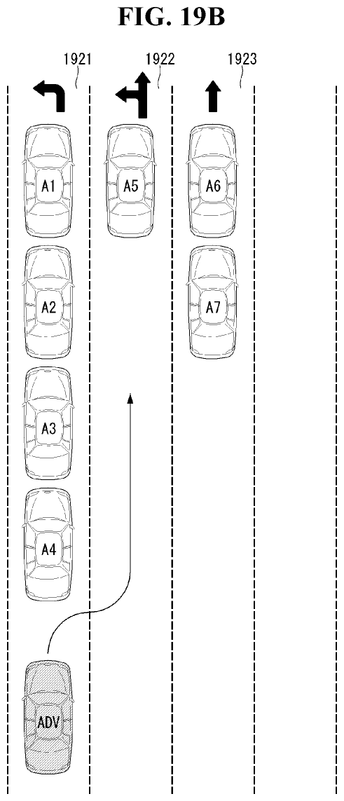

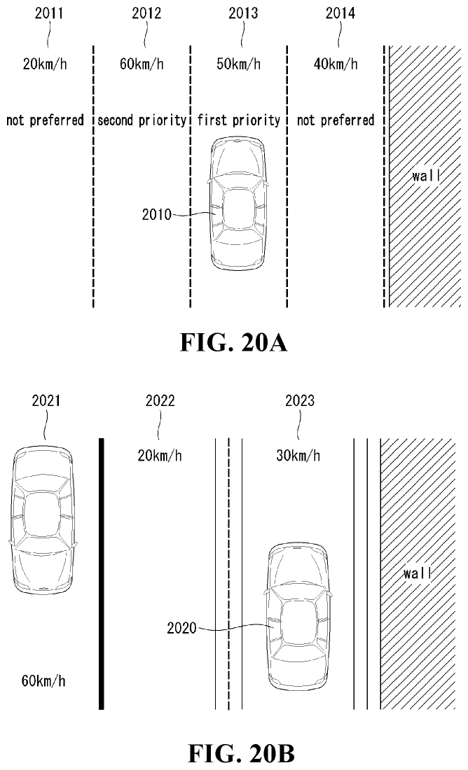

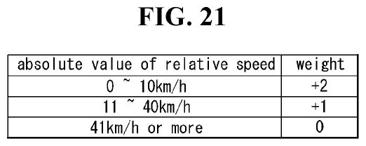

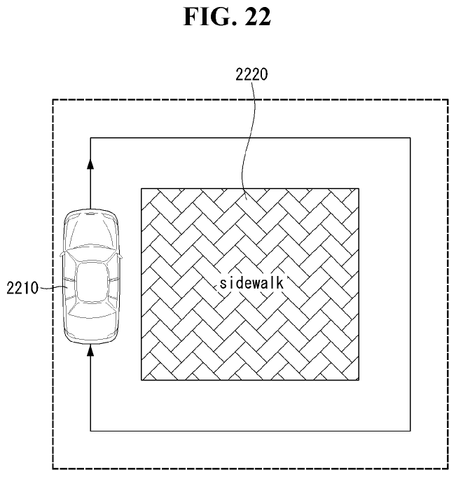

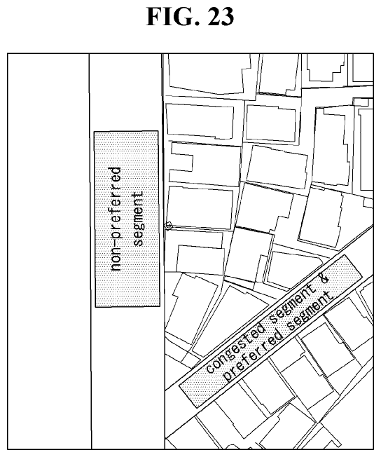

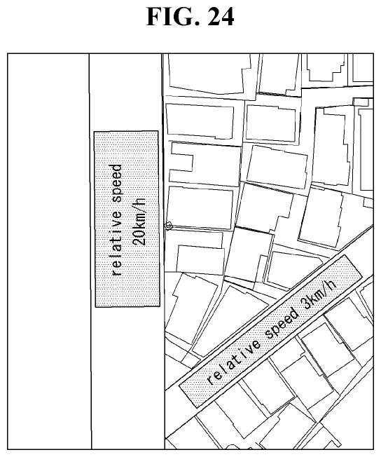

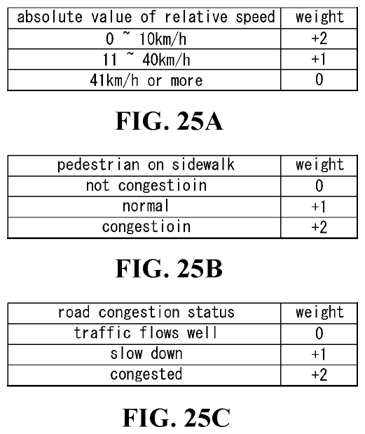

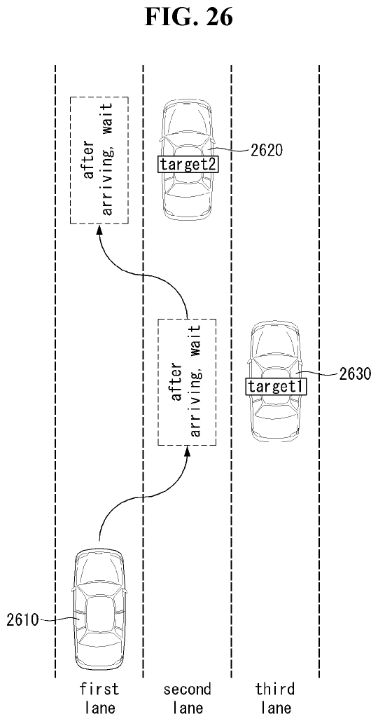

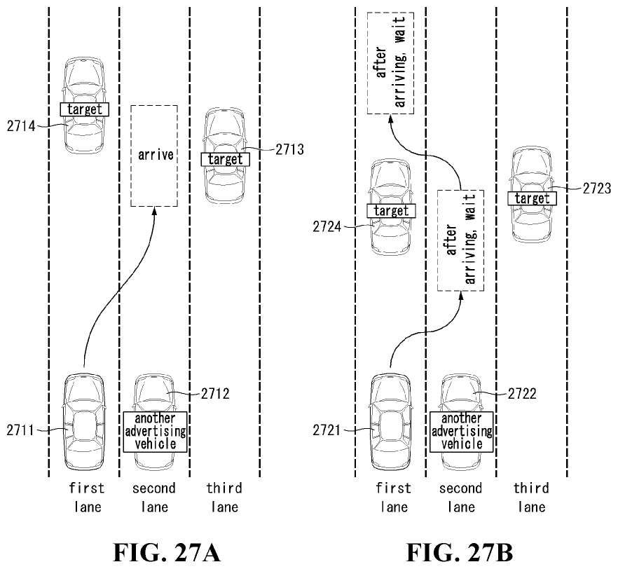

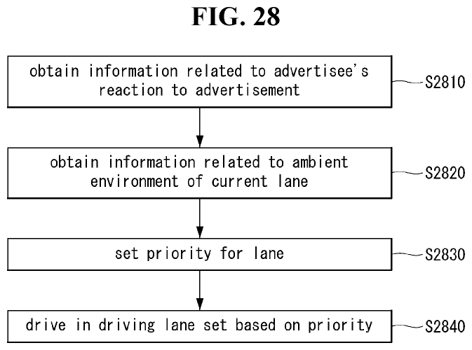

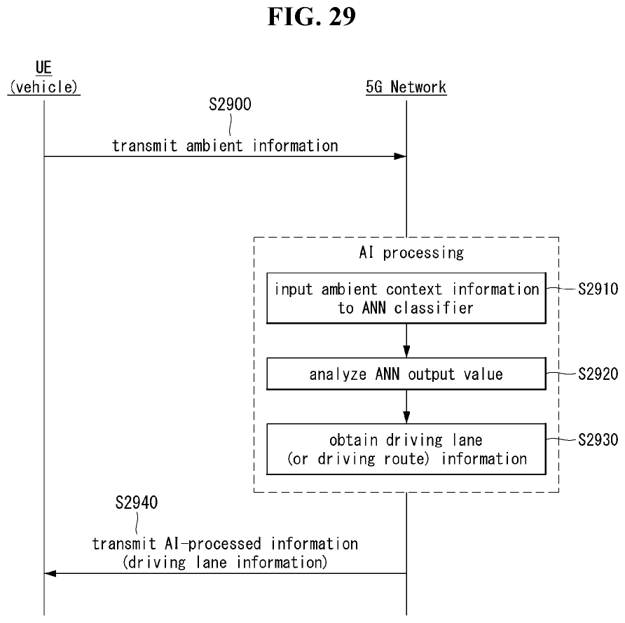

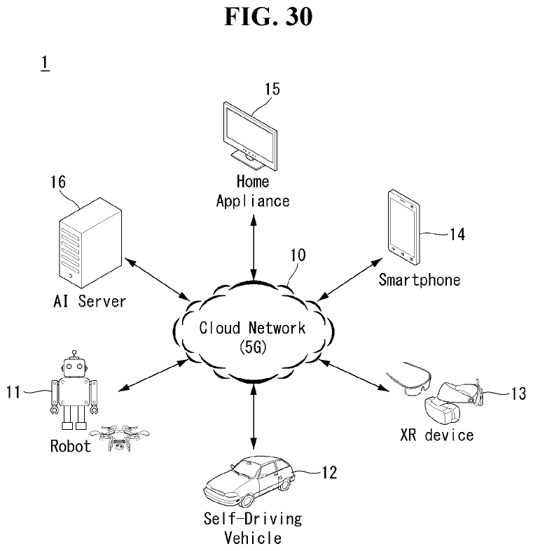

FIG. 11 is a view illustrating an AV providing advertisements according to an embodiment of the present disclosure.

FIG. 12 is a view illustrating an example system of performing a method of setting a driving route of an AV according to an embodiment of the present disclosure.

FIG. 13 is a flowchart illustrating an example method of setting a driving route of an AV according to an embodiment of the present disclosure.

FIG. 14 is a flowchart illustrating an example method of setting a driving route of an AV according to an embodiment of the present disclosure.

FIG. 15 is a flowchart illustrating an example method of setting a driving route of an AV according to an embodiment of the present disclosure.

FIG. 16 is a view illustrating an example of performing a method of setting a driving route of an AV according to an embodiment of the present disclosure.

FIG. 17 is a view illustrating an example of performing a method of setting a driving route of an AV according to an embodiment of the present disclosure.

FIGS. 18A and 18B are views illustrating an example of performing a method of setting a driving route of an AV according to an embodiment of the present disclosure.

FIGS. 19A and 19B are views illustrating an example of performing a method of setting a driving route of an AV according to an embodiment of the present disclosure.

FIGS. 20A and 20B are views illustrating an example of performing a method of setting a driving route of an AV according to an embodiment of the present disclosure.

FIG. 21 is a view illustrating an example of performing a method of setting a driving route of an AV according to an embodiment of the present disclosure.

FIG. 22 is a view illustrating an example of performing a method of setting a driving route of an AV according to an embodiment of the present disclosure.

FIG. 23 is a view illustrating an example of performing a method of setting a driving route of an AV according to an embodiment of the present disclosure.

FIG. 24 is a view illustrating an example of performing a method of setting a driving route of an AV according to an embodiment of the present disclosure.

FIGS. 25A through 25C are flowcharts illustrating an example of performing a method of setting a driving route of an AV according to an embodiment of the present disclosure.

FIG. 26 is a view illustrating an example of performing a method of setting a driving route of an AV according to an embodiment of the present disclosure.

FIGS. 27A and 27B are views illustrating an example of performing a method of setting a driving route of an AV according to an embodiment of the present disclosure.

FIG. 28 is a flowchart illustrating an example of performing a method of setting a driving route of an AV according to an embodiment of the present disclosure.

FIG. 29 is a flowchart illustrating an example of performing a method of setting a driving route of an AV according to an embodiment of the present disclosure.

FIG. 30 is a view illustrating an AI system connected via a 5G communication network according to an embodiment of the present disclosure.

### DETAILED DESCRIPTION

Hereinafter, embodiments of the disclosure will be described in detail with reference to the attached drawings. The same or similar components are given the same reference numbers and redundant description thereof is omitted. The suffixes “module” and “unit” of elements herein are used for convenience of description and thus can be used interchangeably and do not have any distinguishable meanings or functions. Further, in the following description, if a detailed description of known techniques associated with the present disclosure would unnecessarily obscure the gist of the present disclosure, detailed description thereof will be omitted. In addition, the attached drawings are provided for easy understanding of embodiments of the disclosure and do not limit technical spirits of the disclosure, and the embodiments should be construed as including all modifications, equivalents, and alternatives falling within the spirit and scope of the embodiments.

While terms, such as “first”, “second”, etc., may be used to describe various components, such components must not be limited by the above terms. The above terms are used only to distinguish one component from another.

When an element is “coupled” or “connected” to another element, it should be understood that a third element may be present between the two elements although the element may be directly coupled or connected to the other element. When an element is “directly coupled” or “directly connected” to another element, it should be understood that no element is present between the two elements.

The singular forms are intended to include the plural forms as well, unless the context clearly indicates otherwise.

In addition, in the specification, it will be further understood that the terms “comprise” and “include” specify the presence of stated features, integers, steps, operations, elements, components, and/or combinations thereof, but do not preclude the presence or addition of one or more other features, integers, steps, operations, elements, components, and/or combinations.

A. Example of Block Diagram of UE and 5G Network

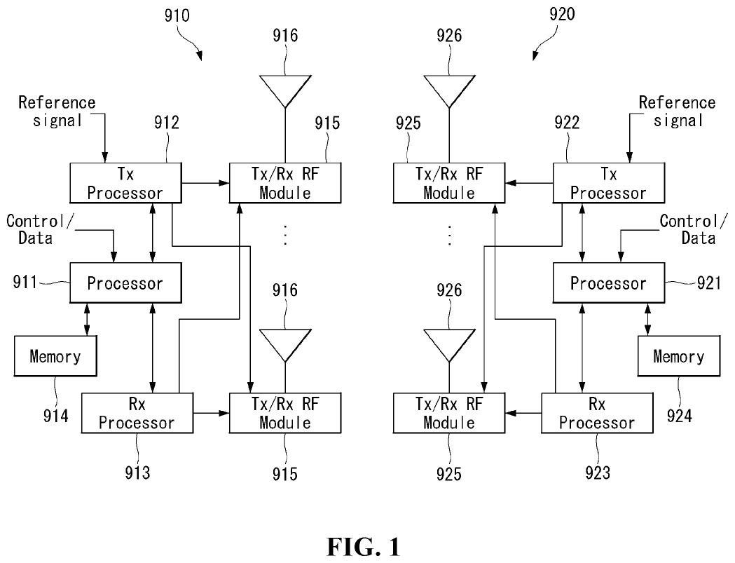

FIG. 1 is a block diagram of a wireless communication system to which methods proposed in the disclosure are applicable.

Referring to FIG. 1, a device (autonomous device) including an autonomous module is defined as a first communication device (910 of FIG. 1), and a processor 911 can perform detailed autonomous operations.

A 5G network including another vehicle communicating with the autonomous device is defined as a second communication device (920 of FIG. 1), and a processor 921 can perform detailed autonomous operations.

The 5G network may be represented as the first communication device and the autonomous device may be represented as the second communication device.

For example, the first communication device or the second communication device may be a base station, a network node, a transmission terminal, a reception terminal, a wireless device, a wireless communication device, an autonomous device, or the like.

For example, a terminal or user equipment (UE) may include a vehicle, a cellular phone, a smart phone, a laptop computer, a digital broadcast terminal, personal digital assistants (PDAs), a portable multimedia player (PMP), a navigation device, a slate PC, a tablet PC, an ultrabook, a wearable device (e.g., a smartwatch, a smart glass and a head mounted display (HMD)), etc. For example, the HMD may be a display device worn on the head of a user. For example, the HMD may be used to realize VR, AR or MR. Referring to FIG. 1, the first communication device 910 and the second communication device 920 include processors 911 and 921, memories 914 and 924, one or more Tx/Rx radio frequency (RF) modules 915 and 925, Tx processors 912 and 922, Rx processors 913 and 923, and antennas 916 and 926. The Tx/Rx module is also referred to as a transceiver. Each Tx/Rx module 915 transmits a signal through each antenna 926. The processor implements the aforementioned functions, processes and/or methods. The processor 921 may be related to the memory 924 that stores program code and data. The memory may be referred to as a computer-readable medium. More specifically, the Tx processor 912 implements various signal processing functions with respect to L1 (i.e., physical layer) in DL (communication from the first communication device to the second communication device). The Rx processor implements various signal processing functions of L1 (i.e., physical layer).

UL (communication from the second communication device to the first communication device) is processed in the first communication device 910 in a way similar to that described in association with a receiver function in the second communication device 920. Each Tx/Rx module 925 receives a signal through each antenna 926. Each Tx/Rx module provides RF carriers and information to the Rx processor 923. The processor 921 may be related to the memory 924 that stores program code and data. The memory may be referred to as a computer-readable medium.

B. Signal Transmission/Reception Method in Wireless Communication System

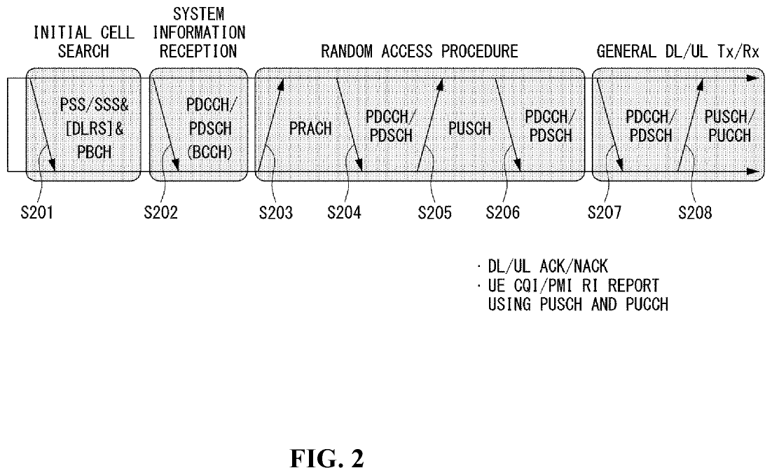

FIG. 2 is a diagram showing an example of a signal transmission/reception method in a wireless communication system.

Referring to FIG. 2, when a UE is powered on or enters a new cell, the UE performs an initial cell search operation such as synchronization with a BS (S201). For this operation, the UE can receive a primary synchronization channel (P-SCH) and a secondary synchronization channel (S-SCH) from the BS to synchronize with the BS and acquire information such as a cell ID. In LTE and NR systems, the P-SCH and S-SCH are respectively called a primary synchronization signal (PSS) and a secondary synchronization signal (SSS). After initial cell search, the UE can acquire broadcast information in the cell by receiving a physical broadcast channel (PBCH) from the BS. Further, the UE can receive a downlink reference signal (DL RS) in the initial cell search step to check a downlink channel state. After initial cell search, the UE can acquire more detailed system information by receiving a physical downlink shared channel (PDSCH) according to a physical downlink control channel (PDCCH) and information included in the PDCCH (S202).

Meanwhile, when the UE initially accesses the BS or has no radio resource for signal transmission, the UE can perform a random access procedure (RACH) for the BS (steps S203 to S206). To this end, the UE can transmit a specific sequence as a preamble through a physical random access channel (PRACH) (S203 and S205) and receive a random access response (RAR) message for the preamble through a PDCCH and a corresponding PDSCH (S204 and S206). In the case of a contention-based RACH, a contention resolution procedure may be additionally performed.

After the UE performs the above-described process, the UE can perform PDCCH/PDSCH reception (S207) and physical uplink shared channel (PUSCH)/physical uplink control channel (PUCCH) transmission (S208) as normal uplink/downlink signal transmission processes. Particularly, the UE receives downlink control information (DCI) through the PDCCH. The UE monitors a set of PDCCH candidates in monitoring occasions set for one or more control element sets (CORESET) on a serving cell according to corresponding search space configurations. A set of PDCCH candidates to be monitored by the UE is defined in terms of search space sets, and a search space set may be a common search space set or a UE-specific search space set. CORESET includes a set of (physical) resource blocks having a duration of one to three OFDM symbols. A network can configure the UE such that the UE has a plurality of CORESETs. The UE monitors PDCCH candidates in one or more search space sets. Here, monitoring means attempting decoding of PDCCH candidate(s) in a search space. When the UE has successfully decoded one of PDCCH candidates in a search space, the UE determines that a PDCCH has been detected from the PDCCH candidate and performs PDSCH reception or PUSCH transmission on the basis of DCI in the detected PDCCH. The PDCCH can be used to schedule DL transmissions over a PDSCH and UL transmissions over a PUSCH. Here, the DCI in the PDCCH includes downlink assignment (i.e., downlink grant (DL grant)) related to a physical downlink shared channel and including at least a modulation and coding format and resource allocation information, or an uplink grant (UL grant) related to a physical uplink shared channel and including a modulation and coding format and resource allocation information.

An initial access (IA) procedure in a 5G communication system will be additionally described with reference to FIG. 2.

The UE can perform cell search, system information acquisition, beam alignment for initial access, and DL measurement on the basis of an SSB. The SSB is interchangeably used with a synchronization signal/physical broadcast channel (SS/PBCH) block.

The SSB includes a PSS, an SSS and a PBCH. The SSB is configured in four consecutive OFDM symbols, and a PSS, a PBCH, an SSS/PBCH or a PBCH is transmitted for each OFDM symbol. Each of the PSS and the SSS includes one OFDM symbol and 127 subcarriers, and the PBCH includes 3 OFDM symbols and 576 subcarriers.

Cell search refers to a process in which a UE acquires time/frequency synchronization of a cell and detects a cell identifier (ID) (e.g., physical layer cell ID (PCI)) of the cell. The PSS is used to detect a cell ID in a cell ID group and the SSS is used to detect a cell ID group. The PBCH is used to detect an SSB (time) index and a half-frame.

There are 336 cell ID groups and there are 3 cell IDs per cell ID group. A total of 1008 cell IDs are present. Information on a cell ID group to which a cell ID of a cell belongs is provided/acquired through an SSS of the cell, and information on the cell ID among 336 cell ID groups is provided/acquired through a PSS.

The SSB is periodically transmitted in accordance with SSB periodicity. A default SSB periodicity assumed by a UE during initial cell search is defined as 20 ms. After cell access, the SSB periodicity can be set to one of {5 ms, 10 ms, 20 ms, 40 ms, 80 ms, 160 ms} by a network (e.g., a BS).

Next, acquisition of system information (SI) will be described.

SI is divided into a master information block (MIB) and a plurality of system information blocks (SIBs). SI other than the MIB may be referred to as remaining minimum system information. The MIB includes information/parameter for monitoring a PDCCH that schedules a PDSCH carrying SIB1 (SystemInformationBlock1) and is transmitted by a BS through a PBCH of an SSB. SIB1 includes information related to availability and scheduling (e.g., transmission periodicity and SI-window size) of the remaining SIBs (hereinafter, SIBx, x is an integer equal to or greater than 2). SiBx is included in an SI message and transmitted over a PDSCH. Each SI message is transmitted within a periodically generated time window (i.e., SI-window).

A random access (RA) procedure in a 5G communication system will be additionally described with reference to FIG. 2.

A random access procedure is used for various purposes. For example, the random access procedure can be used for network initial access, handover, and UE-triggered UL data transmission. A UE can acquire UL synchronization and UL transmission resources through the random access procedure. The random access procedure is classified into a contention-based random access procedure and a contention-free random access procedure. A detailed procedure for the contention-based random access procedure is as follows.

A UE can transmit a random access preamble through a PRACH as Msg1 of a random access procedure in UL. Random access preamble sequences having different two lengths are supported. A long sequence length 839 is applied to subcarrier spacings of 1.25 kHz and 5 kHz and a short sequence length 139 is applied to subcarrier spacings of 15 kHz, 30 kHz, 60 kHz and 120 kHz.

When a BS receives the random access preamble from the UE, the BS transmits a random access response (RAR) message (Msg2) to the UE. A PDCCH that schedules a PDSCH carrying a RAR is CRC masked by a random access (RA) radio network temporary identifier (RNTI) (RA-RNTI) and transmitted. Upon detection of the PDCCH masked by the RA-RNTI, the UE can receive a RAR from the PDSCH scheduled by DCI carried by the PDCCH. The UE checks whether the RAR includes random access response information with respect to the preamble transmitted by the UE, that is, Msg1. Presence or absence of random access information with respect to Msg1 transmitted by the UE can be determined according to presence or absence of a random access preamble ID with respect to the preamble transmitted by the UE. If there is no response to Msg1, the UE can retransmit the RACH preamble less than a predetermined number of times while performing power ramping. The UE calculates PRACH transmission power for preamble retransmission on the basis of most recent pathloss and a power ramping counter.

The UE can perform UL transmission through Msg3 of the random access procedure over a physical uplink shared channel on the basis of the random access response information. Msg3 can include an RRC connection request and a UE ID. The network can transmit Msg4 as a response to Msg3, and Msg4 can be handled as a contention resolution message on DL. The UE can enter an RRC connected state by receiving Msg4.

C. Beam Management (BM) Procedure of 5G Communication System

A BM procedure can be divided into (1) a DL MB procedure using an SSB or a CSI-RS and (2) a UL BM procedure using a sounding reference signal (SRS). In addition, each BM procedure can include Tx beam swiping for determining a Tx beam and Rx beam swiping for determining an Rx beam.

The DL BM procedure using an SSB will be described.

Configuration of a beam report using an SSB is performed when channel state information (CSI)/beam is configured in RRC_CONNECTED.
A UE receives a CSI-ResourceConfig IE including CSI-SSB-ResourceSetList for SSB resources used for BM from a BS. The RRC parameter “csi-SSB-ResourceSetList” represents a list of SSB resources used for beam management and report in one resource set. Here, an SSB resource set can be set as {SSBx1, SSBx2, SSBx3, SSBx4, . . . }. An SSB index can be defined in the range of 0 to 63.
The UE receives the signals on SSB resources from the BS on the basis of the CSI-SSB-ResourceSetList.
When CSI-RS reportConfig with respect to a report on SSBRI and reference signal received power (RSRP) is set, the UE reports the best SSBRI and RSRP corresponding thereto to the BS. For example, when reportQuantity of the CSI-RS reportConfig IE is set to ‘ssb-Index-RSRP’, the UE reports the best SSBRI and RSRP corresponding thereto to the BS.

When a CSI-RS resource is configured in the same OFDM symbols as an SSB and ‘QCL-TypeD’ is applicable, the UE can assume that the CSI-RS and the SSB are quasi co-located (QCL) from the viewpoint of ‘QCL-TypeD’. Here, QCL-TypeD may mean that antenna ports are quasi co-located from the viewpoint of a spatial Rx parameter. When the UE receives signals of a plurality of DL antenna ports in a QCL-TypeD relationship, the same Rx beam can be applied.

Next, a DL BM procedure using a CSI-RS will be described.

An Rx beam determination (or refinement) procedure of a UE and a Tx beam swiping procedure of a BS using a CSI-RS will be sequentially described. A repetition parameter is set to ‘ON’ in the Rx beam determination procedure of a UE and set to ‘OFF’ in the Tx beam swiping procedure of a BS.

First, the Rx beam determination procedure of a UE will be described.
The UE receives an NZP CSI-RS resource set IE including an RRC parameter with respect to ‘repetition’ from a BS through RRC signaling. Here, the RRC parameter ‘repetition’ is set to ‘ON’.
The UE repeatedly receives signals on resources in a CSI-RS resource set in which the RRC parameter ‘repetition’ is set to ‘ON’ in different OFDM symbols through the same Tx beam (or DL spatial domain transmission filters) of the BS.
The UE determines an RX beam thereof
The UE skips a CSI report. That is, the UE can skip a CSI report when the RRC parameter ‘repetition’ is set to ‘ON’.

Next, the Tx beam determination procedure of a BS will be described.
A UE receives an NZP CSI-RS resource set IE including an RRC parameter with respect to ‘repetition’ from the BS through RRC signaling. Here, the RRC parameter ‘repetition’ is related to the Tx beam swiping procedure of the BS when set to ‘OFF’.
The UE receives signals on resources in a CSI-RS resource set in which the RRC parameter ‘repetition’ is set to ‘OFF’ in different DL spatial domain transmission filters of the BS.
The UE selects (or determines) a best beam.
The UE reports an ID (e.g., CRI) of the selected beam and related quality information (e.g., RSRP) to the BS. That is, when a CSI-RS is transmitted for BM, the UE reports a CRI and RSRP with respect thereto to the BS.

Next, the UL BM procedure using an SRS will be described.
A UE receives RRC signaling (e.g., SRS-Config IE) including a (RRC parameter) purpose parameter set to ‘beam management” from a BS. The SRS-Config IE is used to set SRS transmission. The SRS-Config IE includes a list of SRS-Resources and a list of SRS-ResourceSets. Each SRS resource set refers to a set of SRS-resources.

The UE determines Tx beamforming for SRS resources to be transmitted on the basis of SRS-SpatialRelation Info included in the SRS-Config IE. Here, SRS-SpatialRelation Info is set for each SRS resource and indicates whether the same beamforming as that used for an SSB, a CSI-RS or an SRS will be applied for each SRS resource.
When SRS-SpatialRelationInfo is set for SRS resources, the same beamforming as that used for the SSB, CSI-RS or SRS is applied. However, when SRS-SpatialRelationInfo is not set for SRS resources, the UE arbitrarily determines Tx beamforming and transmits an SRS through the determined Tx beamforming.

Next, a beam failure recovery (BFR) procedure will be described.

In a beamformed system, radio link failure (RLF) may frequently occur due to rotation, movement or beamforming blockage of a UE. Accordingly, NR supports BFR in order to prevent frequent occurrence of RLF. BFR is similar to a radio link failure recovery procedure and can be supported when a UE knows new candidate beams. For beam failure detection, a BS configures beam failure detection reference signals for a UE, and the UE declares beam failure when the number of beam failure indications from the physical layer of the UE reaches a threshold set through RRC signaling within a period set through RRC signaling of the BS. After beam failure detection, the UE triggers beam failure recovery by initiating a random access procedure in a PCell and performs beam failure recovery by selecting a suitable beam. (When the BS provides dedicated random access resources for certain beams, these are prioritized by the UE). Completion of the aforementioned random access procedure is regarded as completion of beam failure recovery.

D. URLLC (Ultra-Reliable and Low Latency Communication)

URLLC transmission defined in NR can refer to (1) a relatively low traffic size, (2) a relatively low arrival rate, (3) extremely low latency requirements (e.g., 0.5 and 1 ms), (4) relatively short transmission duration (e.g., 2 OFDM symbols), (5) urgent services/messages, etc. In the case of UL, transmission of traffic of a specific type (e.g., URLLC) needs to be multiplexed with another transmission (e.g., eMBB) scheduled in advance in order to satisfy more stringent latency requirements. In this regard, a method of providing information indicating preemption of specific resources to a UE scheduled in advance and allowing a URLLC UE to use the resources for UL transmission is provided.

NR supports dynamic resource sharing between eMBB and URLLC. eMBB and URLLC services can be scheduled on non-overlapping time/frequency resources, and URLLC transmission can occur in resources scheduled for ongoing eMBB traffic. An eMBB UE may not ascertain whether PDSCH transmission of the corresponding UE has been partially punctured and the UE may not decode a PDSCH due to corrupted coded bits. In view of this, NR provides a preemption indication. The preemption indication may also be referred to as an interrupted transmission indication.

With regard to the preemption indication, a UE receives DownlinkPreemption IE through RRC signaling from a BS. When the UE is provided with DownlinkPreemption IE, the UE is configured with INT-RNTI provided by a parameter int-RNTI in DownlinkPreemption IE for monitoring of a PDCCH that conveys DCI format 2_1. The UE is additionally configured with a corresponding set of positions for fields in DCI format 2_1 according to a set of serving cells and positionInDCI by INT-ConfigurationPerServing Cell including a set of serving cell indexes provided by servingCellID, configured having an information payload size for DCI format 2_1 according to dci-Payloadsize, and configured with indication granularity of time-frequency resources according to timeFrequencySect.

The UE receives DCI format 2_1 from the BS on the basis of the DownlinkPreemption IE.

When the UE detects DCI format 2_1 for a serving cell in a configured set of serving cells, the UE can assume that there is no transmission to the UE in PRBs and symbols indicated by the DCI format 2_1 in a set of PRBs and a set of symbols in a last monitoring period before a monitoring period to which the DCI format 2_1 belongs. For example, the UE assumes that a signal in a time-frequency resource indicated according to preemption is not DL transmission scheduled therefor and decodes data on the basis of signals received in the remaining resource region.

E. mMTC (Massive MTC)

mMTC (massive Machine Type Communication) is one of 5G scenarios for supporting a hyper-connection service providing simultaneous communication with a large number of UEs. In this environment, a UE intermittently performs communication with a very low speed and mobility. Accordingly, a main goal of mMTC is operating a UE for a long time at a low cost. With respect to mMTC, 3GPP deals with MTC and NB (NarrowBand)-IoT.

mMTC has features such as repetitive transmission of a PDCCH, a PUCCH, a PDSCH (physical downlink shared channel), a PUSCH, etc., frequency hopping, retuning, and a guard period.

That is, a PUSCH (or a PUCCH (particularly, a long PUCCH) or a PRACH) including specific information and a PDSCH (or a PDCCH) including a response to the specific information are repeatedly transmitted. Repetitive transmission is performed through frequency hopping, and for repetitive transmission, (RF) retuning from a first frequency resource to a second frequency resource is performed in a guard period and the specific information and the response to the specific information can be transmitted/received through a narrowband (e.g., 6 resource blocks (RBs) or 1 RB).

F. Basic Operation Between Autonomous Vehicles Using 5G Communication

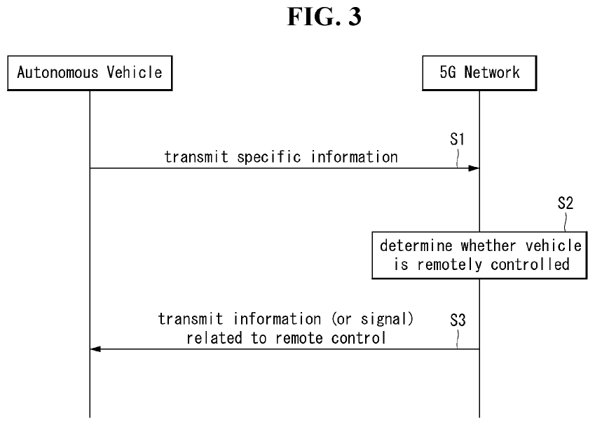

FIG. 3 shows an example of basic operations of an autonomous vehicle and a 5G network in a 5G communication system.

The autonomous vehicle transmits specific information to the 5G network (S1). The specific information may include autonomous driving related information. In addition, the 5G network can determine whether to remotely control the vehicle (S2). Here, the 5G network may include a server or a module which performs remote control related to autonomous driving. In addition, the 5G network can transmit information (or signal) related to remote control to the autonomous vehicle (S3).

G. Applied Operations Between Autonomous Vehicle and 5G Network in 5G Communication System

Hereinafter, the operation of an autonomous vehicle using 5G communication will be described in more detail with reference to wireless communication technology (BM procedure, URLLC, mMTC, etc.) described in FIGS. 1 and 2.

First, a basic procedure of an applied operation to which a method proposed by the present disclosure which will be described later and eMBB of 5G communication are applied will be described.

As in steps S1 and S3 of FIG. 3, the autonomous vehicle performs an initial access procedure and a random access procedure with the 5G network prior to step S1 of FIG. 3 in order to transmit/receive signals, information and the like to/from the 5G network.

More specifically, the autonomous vehicle performs an initial access procedure with the 5G network on the basis of an SSB in order to acquire DL synchronization and system information. A beam management (BM) procedure and a beam failure recovery procedure may be added in the initial access procedure, and quasi-co-location (QCL) relation may be added in a process in which the autonomous vehicle receives a signal from the 5G network.

In addition, the autonomous vehicle performs a random access procedure with the 5G network for UL synchronization acquisition and/or UL transmission. The 5G network can transmit, to the autonomous vehicle, a UL grant for scheduling transmission of specific information. Accordingly, the autonomous vehicle transmits the specific information to the 5G network on the basis of the UL grant. In addition, the 5G network transmits, to the autonomous vehicle, a DL grant for scheduling transmission of 5G processing results with respect to the specific information. Accordingly, the 5G network can transmit, to the autonomous vehicle, information (or a signal) related to remote control on the basis of the DL grant.

Next, a basic procedure of an applied operation to which a method proposed by the present disclosure which will be described later and URLLC of 5G communication are applied will be described.

As described above, an autonomous vehicle can receive DownlinkPreemption IE from the 5G network after the autonomous vehicle performs an initial access procedure and/or a random access procedure with the 5G network. Then, the autonomous vehicle receives DCI format 2_1 including a preemption indication from the 5G network on the basis of DownlinkPreemption IE. The autonomous vehicle does not perform (or expect or assume) reception of eMBB data in resources (PRBs and/or OFDM symbols) indicated by the preemption indication. Thereafter, when the autonomous vehicle needs to transmit specific information, the autonomous vehicle can receive a UL grant from the 5G network.

Next, a basic procedure of an applied operation to which a method proposed by the present disclosure which will be described later and mMTC of 5G communication are applied will be described.

Description will focus on parts in the steps of FIG. 3 which are changed according to application of mMTC.

In step S1 of FIG. 3, the autonomous vehicle receives a UL grant from the 5G network in order to transmit specific information to the 5G network. Here, the UL grant may include information on the number of repetitions of transmission of the specific information and the specific information may be repeatedly transmitted on the basis of the information on the number of repetitions. That is, the autonomous vehicle transmits the specific information to the 5G network on the basis of the UL grant. Repetitive transmission of the specific information may be performed through frequency hopping, the first transmission of the specific information may be performed in a first frequency resource, and the second transmission of the specific information may be performed in a second frequency resource. The specific information can be transmitted through a narrowband of 6 resource blocks (RBs) or 1 RB.

H. Autonomous driving operation between vehicles using 5G communication

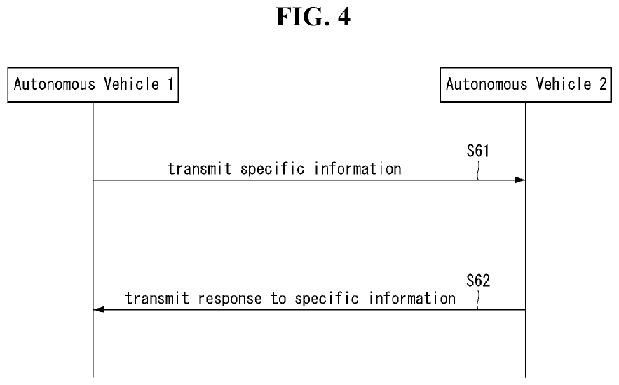

FIG. 4 shows an example of a basic operation between vehicles using 5G communication.

A first vehicle transmits specific information to a second vehicle (S61). The second vehicle transmits a response to the specific information to the first vehicle (S62).

Meanwhile, a configuration of an applied operation between vehicles may depend on whether the 5G network is directly (sidelink communication transmission mode 3) or indirectly (sidelink communication transmission mode 4) involved in resource allocation for the specific information and the response to the specific information.

Next, an applied operation between vehicles using 5G communication will be described.

First, a method in which a 5G network is directly involved in resource allocation for signal transmission/reception between vehicles will be described.

The 5G network can transmit DCI format 5A to the first vehicle for scheduling of mode-3 transmission (PSCCH and/or PSSCH transmission). Here, a physical sidelink control channel (PSCCH) is a 5G physical channel for scheduling of transmission of specific information a physical sidelink shared channel (PSSCH) is a 5G physical channel for transmission of specific information. In addition, the first vehicle transmits SCI format 1 for scheduling of specific information transmission to the second vehicle over a PSCCH. Then, the first vehicle transmits the specific information to the second vehicle over a PSSCH.

Next, a method in which a 5G network is indirectly involved in resource allocation for signal transmission/reception will be described.

The first vehicle senses resources for mode-4 transmission in a first window. Then, the first vehicle selects resources for mode-4 transmission in a second window on the basis of the sensing result. Here, the first window refers to a sensing window and the second window refers to a selection window. The first vehicle transmits SCI format 1 for scheduling of transmission of specific information to the second vehicle over a PSCCH on the basis of the selected resources. Then, the first vehicle transmits the specific information to the second vehicle over a PSSCH.

The above-described 5G communication technology can be combined with methods proposed in the present disclosure which will be described later and applied or can complement the methods proposed in the present disclosure to make technical features of the methods concrete and clear.

Driving

(1) Exterior of Vehicle

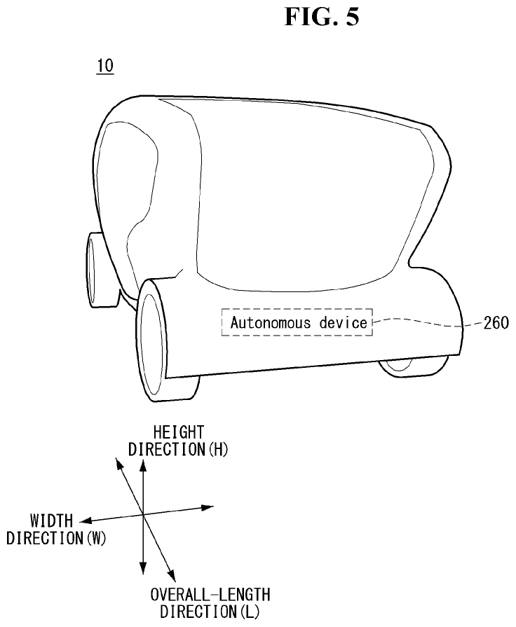

FIG. 5 is a diagram showing a vehicle according to an embodiment of the present disclosure.

Referring to FIG. 5, a vehicle 10 according to an embodiment of the present disclosure is defined as a transportation means traveling on roads or railroads. The vehicle 10 includes a car, a train and a motorcycle. The vehicle 10 may include an internal-combustion engine vehicle having an engine as a power source, a hybrid vehicle having an engine and a motor as a power source, and an electric vehicle having an electric motor as a power source. The vehicle 10 may be a private own vehicle. The vehicle 10 may be a shared vehicle. The vehicle 10 may be an autonomous vehicle.

(2) Components of Vehicle

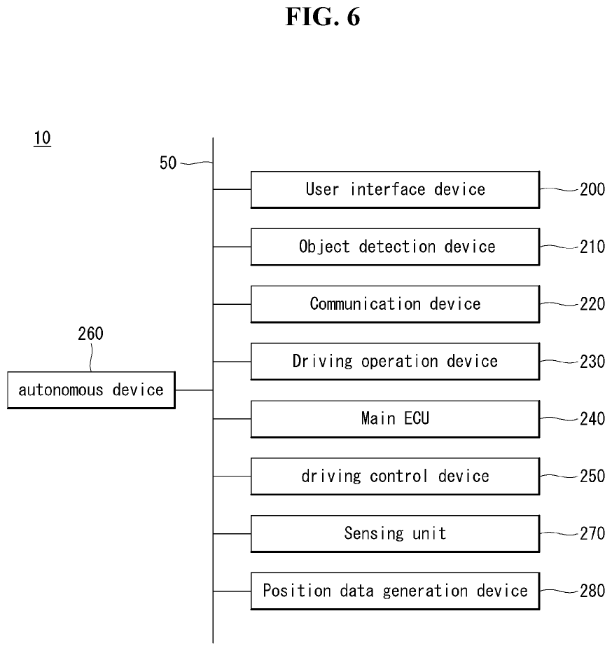

FIG. 6 is a control block diagram of the vehicle according to an embodiment of the present disclosure.

Referring to FIG. 6, the vehicle 10 may include a user interface device 200, an object detection device 210, a communication device 220, a driving operation device 230, a main ECU 240, a driving control device 250, an autonomous device 260, a sensing unit 270, and a position data generation device 280. The object detection device 210, the communication device 220, the driving operation device 230, the main ECU 240, the driving control device 250, the autonomous device 260, the sensing unit 270 and the position data generation device 280 may be realized by electronic devices which generate electric signals and exchange the electric signals from one another.

1) User Interface Device

The user interface device 200 is a device for communication between the vehicle 10 and a user. The user interface device 200 can receive user input and provide information generated in the vehicle 10 to the user. The vehicle 10 can realize a user interface (UI) or user experience (UX) through the user interface device 200. The user interface device 200 may include an input device, an output device and a user monitoring device.

2) Object Detection Device

The object detection device 210 can generate information about objects outside the vehicle 10. Information about an object can include at least one of information on presence or absence of the object, positional information of the object, information on a distance between the vehicle 10 and the object, and information on a relative speed of the vehicle 10 with respect to the object. The object detection device 210 can detect objects outside the vehicle 10. The object detection device 210 may include at least one sensor which can detect objects outside the vehicle 10. The object detection device 210 may include at least one of a camera, a radar, a lidar, an ultrasonic sensor and an infrared sensor. The object detection device 210 can provide data about an object generated on the basis of a sensing signal generated from a sensor to at least one electronic device included in the vehicle.

2.1) Camera

The camera can generate information about objects outside the vehicle 10 using images. The camera may include at least one lens, at least one image sensor, and at least one processor which is electrically connected to the image sensor, processes received signals and generates data about objects on the basis of the processed signals.

The camera may be at least one of a mono camera, a stereo camera and an around view monitoring (AVM) camera. The camera can acquire positional information of objects, information on distances to objects, or information on relative speeds with respect to objects using various image processing algorithms. For example, the camera can acquire information on a distance to an object and information on a relative speed with respect to the object from an acquired image on the basis of change in the size of the object over time. For example, the camera may acquire information on a distance to an object and information on a relative speed with respect to the object through a pin-hole model, road profiling, or the like. For example, the camera may acquire information on a distance to an object and information on a relative speed with respect to the object from a stereo image acquired from a stereo camera on the basis of disparity information.

The camera may be attached at a portion of the vehicle at which FOV (field of view) can be secured in order to photograph the outside of the vehicle. The camera may be disposed in proximity to the front windshield inside the vehicle in order to acquire front view images of the vehicle. The camera may be disposed near a front bumper or a radiator grill. The camera may be disposed in proximity to a rear glass inside the vehicle in order to acquire rear view images of the vehicle. The camera may be disposed near a rear bumper, a trunk or a tail gate. The camera may be disposed in proximity to at least one of side windows inside the vehicle in order to acquire side view images of the vehicle. Alternatively, the camera may be disposed near a side mirror, a fender or a door.

2.2) Radar

The radar can generate information about an object outside the vehicle using electromagnetic waves. The radar may include an electromagnetic wave transmitter, an electromagnetic wave receiver, and at least one processor which is electrically connected to the electromagnetic wave transmitter and the electromagnetic wave receiver, processes received signals and generates data about an object on the basis of the processed signals. The radar may be realized as a pulse radar or a continuous wave radar in terms of electromagnetic wave emission. The continuous wave radar may be realized as a frequency modulated continuous wave (FMCW) radar or a frequency shift keying (FSK) radar according to signal waveform. The radar can detect an object through electromagnetic waves on the basis of TOF (Time of Flight) or phase shift and detect the position of the detected object, a distance to the detected object and a relative speed with respect to the detected object. The radar may be disposed at an appropriate position outside the vehicle in order to detect objects positioned in front of, behind or on the side of the vehicle.

2.3) Lidar

The lidar can generate information about an object outside the vehicle 10 using a laser beam. The lidar may include a light transmitter, a light receiver, and at least one processor which is electrically connected to the light transmitter and the light receiver, processes received signals and generates data about an object on the basis of the processed signal. The lidar may be realized according to TOF or phase shift. The lidar may be realized as a driven type or a non-driven type. A driven type lidar may be rotated by a motor and detect an object around the vehicle 10. A non-driven type lidar may detect an object positioned within a predetermined range from the vehicle according to light steering. The vehicle 10 may include a plurality of non-drive type lidars. The lidar can detect an object through a laser beam on the basis of TOF (Time of Flight) or phase shift and detect the position of the detected object, a distance to the detected object and a relative speed with respect to the detected object. The lidar may be disposed at an appropriate position outside the vehicle in order to detect objects positioned in front of, behind or on the side of the vehicle.

3) Communication Device

The communication device 220 can exchange signals with devices disposed outside the vehicle 10. The communication device 220 can exchange signals with at least one of infrastructure (e.g., a server and a broadcast station), another vehicle and a terminal. The communication device 220 may include a transmission antenna, a reception antenna, and at least one of a radio frequency (RF) circuit and an RF element which can implement various communication protocols in order to perform communication.

For example, the communication device can exchange signals with external devices on the basis of C-V2X (Cellular V2X). For example, C-V2X can include sidelink communication based on LTE and/or sidelink communication based on NR. Details related to C-V2X will be described later.

For example, the communication device can exchange signals with external devices on the basis of DSRC (Dedicated Short Range Communications) or WAVE (Wireless Access in Vehicular Environment) standards based on IEEE 802.11p PHY/MAC layer technology and IEEE 1609 Network/Transport layer technology. DSRC (or WAVE standards) is communication specifications for providing an intelligent transport system (ITS) service through short-range dedicated communication between vehicle-mounted devices or between a roadside device and a vehicle-mounted device. DSRC may be a communication scheme that can use a frequency of 5.9 GHz and have a data transfer rate in the range of 3 Mbps to 27 Mbps. IEEE 802.11p may be combined with IEEE 1609 to support DSRC (or WAVE standards).

The communication device of the present disclosure can exchange signals with external devices using only one of C-V2X and DSRC. Alternatively, the communication device of the present disclosure can exchange signals with external devices using a hybrid of C-V2X and DSRC.

4) Driving Operation Device

The driving operation device 230 is a device for receiving user input for driving. In a manual mode, the vehicle 10 may be driven on the basis of a signal provided by the driving operation device 230. The driving operation device 230 may include a steering input device (e.g., a steering wheel), an acceleration input device (e.g., an acceleration pedal) and a brake input device (e.g., a brake pedal).

5) Main ECU

The main ECU 240 can control the overall operation of at least one electronic device included in the vehicle 10.

6) Driving Control Device

The driving control device 250 is a device for electrically controlling various vehicle driving devices included in the vehicle 10. The driving control device 250 may include a power train driving control device, a chassis driving control device, a door/window driving control device, a safety device driving control device, a lamp driving control device, and an air-conditioner driving control device. The power train driving control device may include a power source driving control device and a transmission driving control device. The chassis driving control device may include a steering driving control device, a brake driving control device and a suspension driving control device. Meanwhile, the safety device driving control device may include a seat belt driving control device for seat belt control.

The driving control device 250 includes at least one electronic control device (e.g., a control ECU (Electronic Control Unit)).

The driving control device 250 can control vehicle driving devices on the basis of signals received by the autonomous device 260. For example, the driving control device 250 can control a power train, a steering device and a brake device on the basis of signals received by the autonomous device 260.

7) Autonomous Device

The autonomous device 260 can generate a route for self-driving on the basis of acquired data. The autonomous device 260 can generate a driving plan for traveling along the generated route. The autonomous device 260 can generate a signal for controlling movement of the vehicle according to the driving plan. The autonomous device 260 can provide the signal to the driving control device 250.

The autonomous device 260 can implement at least one ADAS (Advanced Driver Assistance System) function. The ADAS can implement at least one of ACC (Adaptive Cruise Control), AEB (Autonomous Emergency Braking), FCW (Forward Collision Warning), LKA (Lane Keeping Assist), LCA (Lane Change Assist), TFA (Target Following Assist), BSD (Blind Spot Detection), HBA (High Beam Assist), APS (Auto Parking System), a PD collision warning system, TSR (Traffic Sign Recognition), TSA (Traffic Sign Assist), NV (Night Vision), DSM (Driver Status Monitoring) and TJA (Traffic Jam Assist).

The autonomous device 260 can perform switching from a self-driving mode to a manual driving mode or switching from the manual driving mode to the self-driving mode. For example, the autonomous device 260 can switch the mode of the vehicle 10 from the self-driving mode to the manual driving mode or from the manual driving mode to the self-driving mode on the basis of a signal received from the user interface device 200.

8) Sensing Unit

The sensing unit 270 can detect a state of the vehicle. The sensing unit 270 may include at least one of an internal measurement unit (IMU) sensor, a collision sensor, a wheel sensor, a speed sensor, an inclination sensor, a weight sensor, a heading sensor, a position module, a vehicle forward/backward movement sensor, a battery sensor, a fuel sensor, a tire sensor, a steering sensor, a temperature sensor, a humidity sensor, an ultrasonic sensor, an illumination sensor, and a pedal position sensor. Further, the IMU sensor may include one or more of an acceleration sensor, a gyro sensor and a magnetic sensor.

The sensing unit 270 can generate vehicle state data on the basis of a signal generated from at least one sensor. Vehicle state data may be information generated on the basis of data detected by various sensors included in the vehicle. The sensing unit 270 may generate vehicle attitude data, vehicle motion data, vehicle yaw data, vehicle roll data, vehicle pitch data, vehicle collision data, vehicle orientation data, vehicle angle data, vehicle speed data, vehicle acceleration data, vehicle tilt data, vehicle forward/backward movement data, vehicle weight data, battery data, fuel data, tire pressure data, vehicle internal temperature data, vehicle internal humidity data, steering wheel rotation angle data, vehicle external illumination data, data of a pressure applied to an acceleration pedal, data of a pressure applied to a brake panel, etc.

9) Position Data Generation Device

The position data generation device 280 can generate position data of the vehicle 10. The position data generation device 280 may include at least one of a global positioning system (GPS) and a differential global positioning system (DGPS). The position data generation device 280 can generate position data of the vehicle 10 on the basis of a signal generated from at least one of the GPS and the DGPS. According to an embodiment, the position data generation device 280 can correct position data on the basis of at least one of the inertial measurement unit (IMU) sensor of the sensing unit 270 and the camera of the object detection device 210. The position data generation device 280 may also be called a global navigation satellite system (GNSS).

The vehicle 10 may include an internal communication system 50. The plurality of electronic devices included in the vehicle 10 can exchange signals through the internal communication system 50. The signals may include data. The internal communication system 50 can use at least one communication protocol (e.g., CAN, LIN, FlexRay, MOST or Ethernet).

(3) Components of Autonomous Device

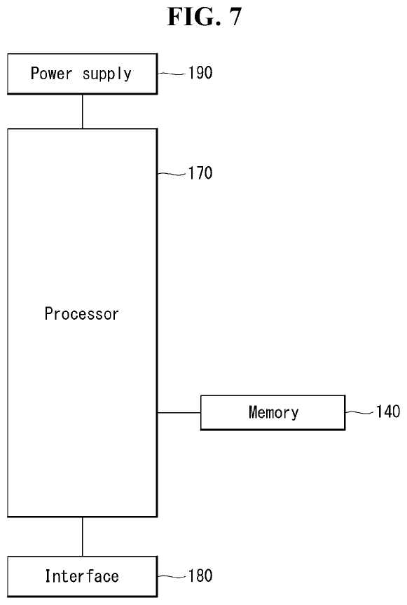

FIG. 7 is a control block diagram of the autonomous device according to an embodiment of the present disclosure.

Referring to FIG. 7, the autonomous device 260 may include a memory 140, a processor 170, an interface 180 and a power supply 190.

The memory 140 is electrically connected to the processor 170. The memory 140 can store basic data with respect to units, control data for operation control of units, and input/output data. The memory 140 can store data processed in the processor 170. Hardware-wise, the memory 140 can be configured as at least one of a ROM, a RAM, an EPROM, a flash drive and a hard drive. The memory 140 can store various types of data for overall operation of the autonomous device 260, such as a program for processing or control of the processor 170. The memory 140 may be integrated with the processor 170. According to an embodiment, the memory 140 may be categorized as a subcomponent of the processor 170.

The interface 180 can exchange signals with at least one electronic device included in the vehicle 10 in a wired or wireless manner. The interface 180 can exchange signals with at least one of the object detection device 210, the communication device 220, the driving operation device 230, the main ECU 240, the driving control device 250, the sensing unit 270 and the position data generation device 280 in a wired or wireless manner. The interface 180 can be configured using at least one of a communication module, a terminal, a pin, a cable, a port, a circuit, an element and a device.

The power supply 190 can provide power to the autonomous device 260. The power supply 190 can be provided with power from a power source (e.g., a battery) included in the vehicle 10 and supply the power to each unit of the autonomous device 260. The power supply 190 can operate according to a control signal supplied from the main ECU 240. The power supply 190 may include a switched-mode power supply (SMPS).

The processor 170 can be electrically connected to the memory 140, the interface 180 and the power supply 190 and exchange signals with these components. The processor 170 can be realized using at least one of application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and electronic units for executing other functions.

The processor 170 can be operated by power supplied from the power supply 190. The processor 170 can receive data, process the data, generate a signal and provide the signal while power is supplied thereto.

The processor 170 can receive information from other electronic devices included in the vehicle 10 through the interface 180. The processor 170 can provide control signals to other electronic devices in the vehicle 10 through the interface 180.

The autonomous device 260 may include at least one printed circuit board (PCB). The memory 140, the interface 180, the power supply 190 and the processor 170 may be electrically connected to the PCB.

(4) Operation of Autonomous Device

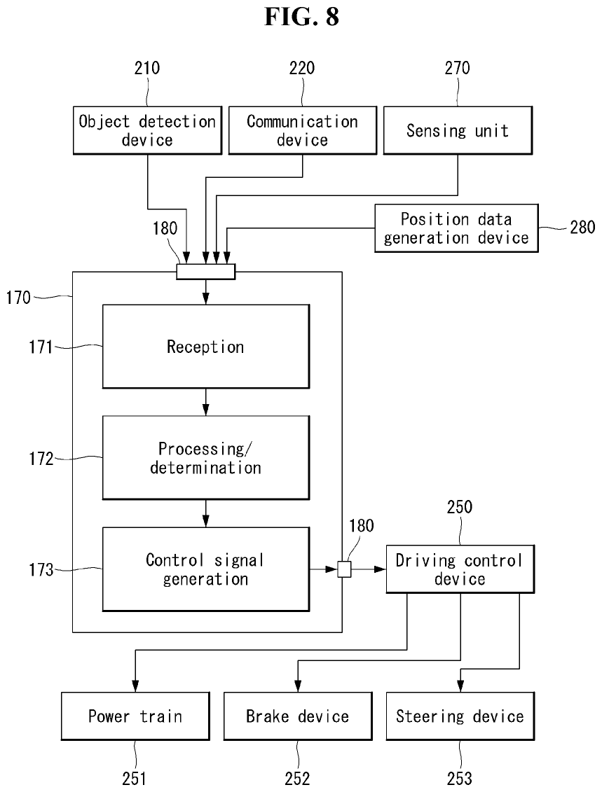

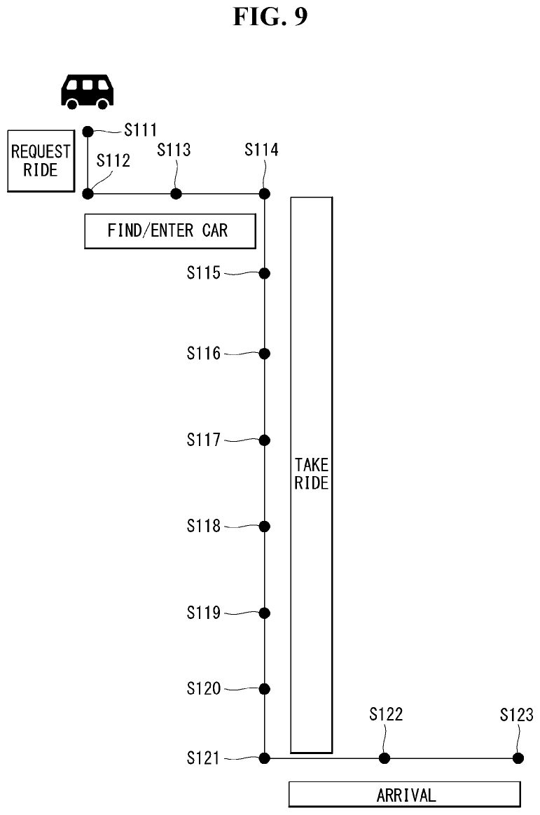

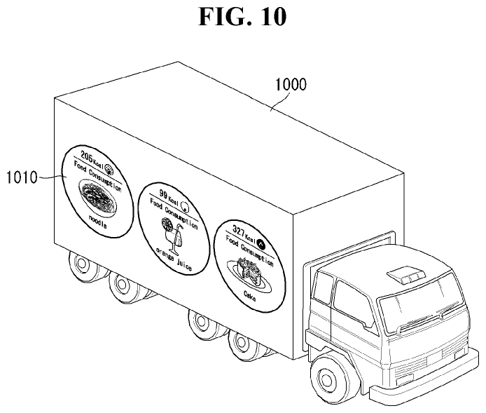

FIG. 8 is a diagram showing a signal flow in an autonomous vehicle according to an embodiment of the present disclosure.

1) Reception Operation

Referring to FIG. 8, the processor 170 can perform a reception operation. The processor 170 can receive data from at least one of the object detection device 210, the communication device 220, the sensing unit 270 and the position data generation device 280 through the interface 180. The processor 170 can receive object data from the object detection device 210. The processor 170 can receive HD map data from the communication device 220. The processor 170 can receive vehicle state data from the sensing unit 270. The processor 170 can receive position data from the position data generation device 280.

2) Processing/Determination Operation

The processor 170 can perform a processing/determination operation. The processor 170 can perform the processing/determination operation on the basis of traveling situation information. The processor 170 can perform the processing/determination operation on the basis of at least one of object data, HD map data, vehicle state data and position data.

2.1) Driving Plan Data Generation Operation

The processor 170 can generate driving plan data. For example, the processor 170 may generate electronic horizon data. The electronic horizon data can be understood as driving plan data in a range from a position at which the vehicle 10 is located to a horizon. The horizon can be understood as a point a predetermined distance before the position at which the vehicle 10 is located on the basis of a predetermined traveling route. The horizon may refer to a point at which the vehicle can arrive after a predetermined time from the position at which the vehicle 10 is located along a predetermined traveling route.

The electronic horizon data can include horizon map data and horizon path data.

2.1.1) Horizon Map Data

The horizon map data may include at least one of topology data, road data, HD map data and dynamic data. According to an embodiment, the horizon map data may include a plurality of layers. For example, the horizon map data may include a first layer that matches the topology data, a second layer that matches the road data, a third layer that matches the HD map data, and a fourth layer that matches the dynamic data. The horizon map data may further include static object data.

The topology data may be explained as a map created by connecting road centers. The topology data is suitable for approximate display of a location of a vehicle and may have a data form used for navigation for drivers. The topology data may be understood as data about road information other than information on driveways. The topology data may be generated on the basis of data received from an external server through the communication device 220. The topology data may be based on data stored in at least one memory included in the vehicle 10.

The road data may include at least one of road slope data, road curvature data and road speed limit data. The road data may further include no-passing zone data. The road data may be based on data received from an external server through the communication device 220. The road data may be based on data generated in the object detection device 210.

The HD map data may include detailed topology information in units of lanes of roads, connection information of each lane, and feature information for vehicle localization (e.g., traffic signs, lane marking/attribute, road furniture, etc.). The HD map data may be based on data received from an external server through the communication device 220.

The dynamic data may include various types of dynamic information which can be generated on roads. For example, the dynamic data may include construction information, variable speed road information, road condition information, traffic information, moving object information, etc. The dynamic data may be based on data received from an external server through the communication device 220. The dynamic data may be based on data generated in the object detection device 210.

The processor 170 can provide map data in a range from a position at which the vehicle 10 is located to the horizon.

2.1.2) Horizon Path Data

The horizon path data may be explained as a trajectory through which the vehicle 10 can travel in a range from a position at which the vehicle 10 is located to the horizon. The horizon path data may include data indicating a relative probability of selecting a road at a decision point (e.g., a fork, a junction, a crossroad, or the like). The relative probability may be calculated on the basis of a time taken to arrive at a final destination. For example, if a time taken to arrive at a final destination is shorter when a first road is selected at a decision point than that when a second road is selected, a probability of selecting the first road can be calculated to be higher than a probability of selecting the second road.

The horizon path data can include a main path and a sub-path. The main path may be understood as a trajectory obtained by connecting roads having a high relative probability of being selected. The sub-path can be branched from at least one decision point on the main path. The sub-path may be understood as a trajectory obtained by connecting at least one road having a low relative probability of being selected at at least one decision point on the main path.

3) Control Signal Generation Operation

The processor 170 can perform a control signal generation operation. The processor 170 can generate a control signal on the basis of the electronic horizon data. For example, the processor 170 may generate at least one of a power train control signal, a brake device control signal and a steering device control signal on the basis of the electronic horizon data.

The processor 170 can transmit the generated control signal to the driving control device 250 through the interface 180. The driving control device 250 can transmit the control signal to at least one of a power train 251, a brake device 252 and a steering device 254.

(2) Autonomous Vehicle Usage Scenarios

FIG. 9 is a diagram referred to in description of a usage scenario of a user according to an embodiment of the present disclosure.

1) Destination Prediction Scenario

A first scenario S111 is a scenario for prediction of a destination of a user. An application which can operate in connection with the cabin system 300 can be installed in a user terminal. The user terminal can predict a destination of a user on the basis of user's contextual information through the application. The user terminal can provide information on unoccupied seats in the cabin through the application.

2) Cabin Interior Layout Preparation Scenario

A second scenario S112 is a cabin interior layout preparation scenario. The cabin system 300 may further include a scanning device for acquiring data about a user located outside the vehicle. The scanning device can scan a user to acquire body data and baggage data of the user. The body data and baggage data of the user can be used to set a layout. The body data of the user can be used for user authentication. The scanning device may include at least one image sensor. The image sensor can acquire a user image using light of the visible band or infrared band.

The seat system 360 can set a cabin interior layout on the basis of at least one of the body data and baggage data of the user. For example, the seat system 360 may provide a baggage compartment or a car seat installation space.

3) User Welcome Scenario

A third scenario S113 is a user welcome scenario. The cabin system 300 may further include at least one guide light. The guide light can be disposed on the floor of the cabin. When a user riding in the vehicle is detected, the cabin system 300 can turn on the guide light such that the user sits on a predetermined seat among a plurality of seats. For example, the main controller 370 may realize a moving light by sequentially turning on a plurality of light sources over time from an open door to a predetermined user seat.

4) Seat Adjustment Service Scenario

A fourth scenario S114 is a seat adjustment service scenario. The seat system 360 can adjust at least one element of a seat that matches a user on the basis of acquired body information.

5) Personal Content Provision Scenario

A fifth scenario S115 is a personal content provision scenario. The display system 350 can receive user personal data through the input device 310 or the communication device 330. The display system 350 can provide content corresponding to the user personal data.

6) Item Provision Scenario

A sixth scenario S116 is an item provision scenario. The cargo system 355 can receive user data through the input device 310 or the communication device 330. The user data may include user preference data, user destination data, etc. The cargo system 355 can provide items on the basis of the user data.

7) Payment Scenario

A seventh scenario S117 is a payment scenario. The payment system 365 can receive data for price calculation from at least one of the input device 310, the communication device 330 and the cargo system 355. The payment system 365 can calculate a price for use of the vehicle by the user on the basis of the received data. The payment system 365 can request payment of the calculated price from the user (e.g., a mobile terminal of the user).

8) Display System Control Scenario of User

An eighth scenario S118 is a display system control scenario of a user. The input device 310 can receive a user input having at least one form and convert the user input into an electrical signal. The display system 350 can control displayed content on the basis of the electrical signal.

9) AI Agent Scenario

A ninth scenario S119 is a multi-channel artificial intelligence (AI) agent scenario for a plurality of users. The AI agent 372 can discriminate user inputs from a plurality of users. The AI agent 372 can control at least one of the display system 350, the cargo system 355, the seat system 360 and the payment system 365 on the basis of electrical signals obtained by converting user inputs from a plurality of users.

10) Multimedia Content Provision Scenario for Multiple Users

A tenth scenario S120 is a multimedia content provision scenario for a plurality of users. The display system 350 can provide content that can be viewed by all users together. In this case, the display system 350 can individually provide the same sound to a plurality of users through speakers provided for respective seats. The display system 350 can provide content that can be individually viewed by a plurality of users. In this case, the display system 350 can provide individual sound through a speaker provided for each seat.

11) User Safety Secure Scenario

An eleventh scenario S121 is a user safety secure scenario. When information on an object around the vehicle which threatens a user is acquired, the main controller 370 can control an alarm with respect to the object around the vehicle to be output through the display system 350.

12) Personal Belongings Loss Prevention Scenario

A twelfth scenario S122 is a user's belongings loss prevention scenario. The main controller 370 can acquire data about user's belongings through the input device 310. The main controller 370 can acquire user motion data through the input device 310. The main controller 370 can determine whether the user exits the vehicle leaving the belongings in the vehicle on the basis of the data about the belongings and the motion data. The main controller 370 can control an alarm with respect to the belongings to be output through the display system 350.

13) Alighting Report Scenario

A thirteenth scenario S123 is an alighting report scenario. The main controller 370 can receive alighting data of a user through the input device 310. After the user exits the vehicle, the main controller 370 can provide report data according to alighting to a mobile terminal of the user through the communication device 330. The report data can include data about a total charge for using the vehicle 10.

An advertising-purposed vehicle (hereinafter, an advertising vehicle) may provide advertisements while repeatedly driving a predetermined segment. When an advertising vehicle sets a driving route, there need to be considered, e.g., the driving route, features of the driving lane, or the degree of reaction to advertisements of people receiving advertisements (also referred to as advertisees).

According to the present disclosure, there is provided a method of setting a driving route of an autonomous vehicle (AV) which is applicable to the above-described system or scenario.

Specifically, there is provided a method of setting a driving route of an advertising-purposed vehicle based on various factors, such as the degree of reaction to advertisements of advertisees or features of the driving lane of the vehicle per driving segment.

The method of setting a driving route of an AV according to the present disclosure may be applicable to advertising-purposed AVs, and the following description focuses primarily on application of the method to advertising-purposed AVs.

However, the method set forth herein is not limited thereto but may rather be applied to setting a driving route of an AV driving for other purposes than advertisement. The method set forth herein is also applicable to other vehicles than AVs.

For illustration purposes, the term “vehicle” used herein encompasses not only AVs but also all other vehicles lacking autonomous driving capability.

The term “advertisee” as used herein refers to a person or thing that receives advertisements from vehicles.

The phrase “A and/or B” may mean “at least one of A or B.”

Now described in detail is a method of setting a driving route of an AV according to the present disclosure.

FIGS. 10 and 11 illustrate an example AV of providing advertisements according to an embodiment of the present disclosure.

FIG. 10 illustrates an example in which an AV 1000 provides advertisements on side surfaces thereof. In this case, advertisements are provided on the left/right side surfaces 1010 of the AV 1000, but not on the front and back surfaces thereof.

FIG. 11 illustrates an example in which advertisements are provided on the front and back surfaces 1120 as well as on the side surfaces 1110 of an AV 1100.

As shown in FIGS. 10 and 11, the area in which advertisements are provided in the vehicle may differ, and different types of methods of setting a driving route according to the present disclosure may be implemented depending on the area in which advertisements are provided.

Although FIGS. 10 and 11 illustrate an example in which the front and back surfaces of the vehicle are distinguished from each other, embodiments of the present disclosure are not limited thereto. For example, embodiments of the present disclosure may also be applied to vehicles of which the front and back surfaces are not distinguished from each other or vehicles that lack a driver seat.

FIG. 12 is a view illustrating an example system of performing a method of setting a driving route of an AV according to an embodiment of the present disclosure.

Referring to FIG. 12, the system may include a plurality of vehicles 1210, 1220, and 1230, a network 1240, and a road context provider server 1250.

The plurality of vehicles 1210, 1220, and 1230 are assumed to be on a road and may communicate with the network 1240. The plurality of vehicles 1210, 1220, and 1230 may gather road context-related to information on their own via sensors equipped therein.

The road context-related information may include speed information for the plurality of vehicles 1210, 1220, and 1230, information for the lanes where the plurality of vehicles are driving, or information for any advertisee present on the sidewalk.

The plurality of vehicles 1210, 1220, and 1230 may receive road context-related information from the network 1240. The road context-related information may include information related to road contexts that the plurality of vehicles 1210, 1220, and 1230 may not directly grasp.

For example, the road context-related information may be pieces of information related to the road context of a specific area which is located far away from the plurality of vehicles 1210, 1220, and 1230, and the road context-related information may include road traffic information, per-road lane mean speed information, speed limit information, and/or information for advertisees on the sidewalk within a specific segment. However, upon arriving at the specific area, the plurality of vehicles 1210, 1220, and 1230 may directly grasp the road context-related information.

As necessary, the plurality of vehicles 1210, 1220, and 1230 may store the road context-related information that they have grasped on their own and/or the road context-related information received from network nodes. The plurality of vehicles 1210, 1220, and 1230 may set a driving route efficiently based on the gathered information or stored information.

Referring to FIG. 12, the network 1240 may communicate with the plurality of vehicles and may provide the road context-related information received from the road context provider server 1250 to the plurality of vehicles 1210, 1220, and 1230. The network 1240 may receive a request for the road context-related information from the plurality of vehicles 1210, 1220, and 1230 and, in response to the request, provide the road context-related information to the plurality of vehicles.

The road context-related information may include road traffic information, per-road lane mean speed information, speed limit information, and/or information for advertisees on the sidewalk within a specific segment.

Referring to FIG. 12, the road context provider server 1250 may provide the road context-related information, which it has received, to the network.

Although not shown in FIG. 12, the road context provider server may receive road context-related information from other servers capable of gathering road context-related information, compile them, and provide the information to the network.

The road context provider server may directly provide the plurality of vehicles 1210, 1220, and 1230 on the road, but rather than providing the road context-related information to the network.

As the components of the system perform the above-described operations, there may be implemented a method of setting a driving route of an AV according to the present disclosure.

A method of setting a driving route of an AV according to the present disclosure is described below in greater detail, focusing on operations performed by the vehicle. However, this is done so solely for illustration purposes, and embodiments of the present disclosure are not limited thereto.

FIG. 13 is a flowchart illustrating an example method of setting a driving route of an AV according to an embodiment of the present disclosure. The operations shown in FIG. 13 may be performed by a processor of the vehicle.

The processor of the vehicle may obtain the degree of reaction, of advertisees, to advertisements that the vehicle provides. The degree of reaction may represent, e.g., the interest that the advertisees show in the advertisements that the vehicle provides. The advertisees may be a number of unspecified people exposed to the advertising vehicle.

The processor may set a driving lane in which the vehicle is to drive according to a predetermined reference so as to efficiently provide advertisements (S1320).

The processor may set a driving route according to a predetermined reference so as to efficiently provide advertisements (S1330).

The processor may set a driving scheme depending on the driving lane and driving route set in steps S1320 and S1330 (S1340).

Specifically, the driving scheme means a driving scheme in which the vehicle temporarily changes lanes while driving depending on the driving lane and driving route set in steps S1320 and S1330 and then changing back to the set lane.

Each operation is described below in greater detail.

FIG. 14 is a flowchart illustrating an example method of setting a driving route of an AV according to an embodiment of the present disclosure.

FIG. 14 specifically illustrates the operation of obtaining information related to the advertisees' reaction to advertisements among operations of a method of setting a driving route of a vehicle according to the present disclosure.

The advertisees may include all of advertisees in vehicles driving on the road and advertisees walking on the sidewalk.

The information related to the advertisees' reaction to advertisements may include reaction levels (values) indicating the degree of interest of the advertisees in the advertisements. The processor of the vehicle may determine the level of reaction to the advertisements of the advertisees based on predetermined references and determine reaction level values. Hereinafter, for illustration purposes, ‘reaction level’ means the reaction level included in the information related to the advertisee's reaction to the advertisement.

The reaction level value included in the information related to the advertisee's reaction to the advertisement may be determined via the process of FIG. 14. The reaction level may be initialized to 0 or a predetermined value and be included in the information related to the advertisee's reaction to the advertisement. For illustration purposes, the initial reaction level value is set to 0.

The processor controls a sensor to obtain the advertisee's gaze at the advertisement that the vehicle provides (S1410).

The advertisee's gaze may be obtained via a gaze recognition sensor provided in the vehicle. The gaze recognition sensor may be, e.g., a camera. The gaze recognition sensor may be sensors separately provided in an advertisement display outputting advertisements, other than the default camera installed in the vehicle to obtain sensing information necessary for driving control. For example, embodiments of the disclosure include operations for an advertising vehicle to set a driving route and driving lane for efficient advertisement. Thus, there may be included in a sensor necessary for driving control and separate sensors for obtaining the level of the advertisee's reaction to the advertisement. The separate sensors for obtaining the level of action to the advertisement may include, e.g., at least one image sensor provided in the bezel of the advertisement display.

The processor determines whether the advertisee gazes at the advertisement for a predetermined time or more based on the advertisee's gaze (S1420).

The predetermined time may be set previously or varied depending on the road context. For example, the predetermined time may be varied depending on the congestion of the ambient road of the advertising vehicle or the sidewalk. Specifically, if the congestion of the ambient road or the sidewalk is determined to be high, the processor may lower the reference time for calculating the level of reaction to the advertisement.

Upon determining that the advertisee is determined not to gaze at the advertisement for the predetermined time or more, the processor determines that the advertisee does not react to the advertisement and terminates the reaction level determination operation (S1431). In this case, the reaction level value included in the information related to the advertisee's reaction to the advertisement is finally determined to be 0.

In contrast, upon determining that the advertisee is determined to gaze at the advertisement for the predetermined time or more, the processor may determine that the advertisee is interested in the advertisement (e.g., interest level 1) (S1430). In this case, a specific weight may be added to the reaction level value included in the information related to the advertisee's reaction to the advertisement. The information related to the advertisee's reaction to the advertisement may mean information for specifying the degree of interest via the advertisee's additional reactions under the assumption that the advertisee has interest in the advertisement the advertising vehicle is providing.

The processor may monitor whether the advertisee makes a specific gesture towards the advertisement (S1440).

For example, the specific gesture may be the advertisee's gesture of spreading her arm and pointing her finger at the advertisement provided by the vehicle, or the specific gesture may encompass other various gestures of the advertisee. In other words, the processor may specify the degree of interest in the advertisement via a gesture additionally monitored after the advertisee has gazed at the advertisement for a predetermined time.

The advertisee's specific gesture may be recognized or captured by a motion recognition sensor provided in the vehicle. The motion recognition sensor may be a camera-equipped sensor.

The processor may determine whether the advertisee makes a specific gesture towards the advertisement based on the specific gesture (S1450).

If the advertisee is determined not to make a specific gesture towards the advertisement, process A shown in FIG. 14 is performed (S1461). Process A is described below with reference to FIG. 15.

In contrast, if the advertisee is determined to make a specific gesture towards the advertisement, the processor may determine that the advertisee has more interest (interest level 2) in the advertisement. In this case, a specific weight may be added to the reaction level value included in the information related to the advertisee's reaction to the advertisement.

Next, the processor may control the sensor to recognize a voice of the advertisee who has more interest (interest level 2) in the advertisement (S1470).

The advertisee's voice may be recognized by a microphone equipped in the vehicle. However, according to an embodiment of the present disclosure, if the distances between the advertising vehicle and advertisees are a predetermined distance or more, it may be hard to obtain, in a voice, the advertisees' reaction to the advertisement. In this case, the advertising vehicle may request other vehicles, which are positioned close to the advertisees, to obtain the advertisees' voice. In other words, the advertising vehicle may receive a V2X message from another vehicle and obtain the voice pattern of the advertisee included in the V2X message, thereby determining the level of the advertisee's reaction to the advertisement.

The advertising vehicle may perform a voice recognition operation on the obtained voice or voice pattern of the advertisee. The voice recognition operation may also be performed via various known voice recognition processes.

The processor analyzes the recognized voice and determines whether the recognized voice contains the content of the advertisement (S1480).

When the recognized voice of the advertisee is determined not to contain the content of advertisement, the processor maintains (+weight 0) the existing reaction level value included in the information related to the advertisee's reaction to the advertisement and terminates the operation of obtaining the information related to the advertisee's reaction to the advertisement (S1491).

The content of advertisement may include any result that may be regarded as substantially related to the output advertisement, such as, e.g., the name of the product to be advertised, information for figures appearing in the advertisement, or location information.

However, according to an embodiment of the present disclosure, if, as a result of voice recognition performed by the advertising vehicle and speech-to-text (STT) conversion of the advertisee's voice, no text as directly related to the advertisement is extracted as described above, but the reaction to the advertisement is identified as, e.g., a shout the meaning of which is hard to figure out, the processor may recognize the advertisee's voice as containing the content of advertisement. If the recognized voice of the advertisee is determined to contain the content of advertisement, the processor may determine that the advertisee has more interest (interest level 3) in the advertisement (S1490). In this case, the predetermined weight may be added to the reaction level value included in the information related to the advertisee's reaction to the advertisement, and the processor terminates the operation of obtaining the information related to the advertisee's reaction to the advertisement.

Described above in connection with FIG. 14 are examples of specifying the degree of interest in an advertisement by configuring the level of the advertisee's reaction to the advertisement the advertising vehicle provides and monitoring the advertisee's reaction at each step.

FIG. 15 is a flowchart illustrating an example method of setting a driving route of an AV according to an embodiment of the present disclosure.

FIG. 15 specifically illustrates process A (S1461) of FIG. 14.

Process A is performed over step S1520 and its subsequent steps. In step S1510, when the processor determines that the advertisee makes no specific gesture towards the advertisee, the reaction level value included in the information related to the advertisee's reaction to the advertisement is maintained (weight+0). Since step S1520 is a step after the advertisee's gaze at the advertisement lasts for a predetermined time or more, the reaction level included in the information related to the advertisee's reaction to the advertisement may be maintained as the existing value.

Next, the processor performs the step of grasping whether the advertisee determined to have interest (interest level 1) in the advertisement makes a mention on the advertisement and its subsequent steps (S1530 to S1560).

The advertisee's mention on the advertisement means the advertisee's utterance on the advertisement of the advertising vehicle as set forth above. The level of the advertisee's interest in the advertisement may be inferred by analyzing the utterance.

Steps S1530 to S1560 are substantially the same as the operations subsequent to step S1470 of FIG. 14 and, thus, no description thereof is given below.

FIG. 16 is a view illustrating a method of calculating a weight for each specific reaction to an advertisement of an advertisee. Specifically, FIG. 16 illustrates an example of assigning a weight to the level of reaction to an advertisement as a result of dividing the level of the advertisee's interest in the advertisement and monitoring the advertisee's reaction in each step of FIGS. 14 to 15.

For example, weight 1 is added to the reaction level for the advertisee's gazing reaction, weight 2 is added for the specific gesture reaction, and weight 3 is added if a mention is made on the advertisement.

Specifically, if the advertisee makes only gazing and specific gestures, the reaction level may be 4.

Described above is a specific method of determining the advertisee's interest in the advertisement that the advertising vehicle provides. Described below is a method by which an advertising AV sets a driving alert depending on the determined interest level.

The operation of setting a lane of operations of a method of setting a driving route of an AV according to the present disclosure is described below in detail with reference to FIGS. 17 to 20.

A processor of a vehicle may set a driving lane based on, e.g., whether a sidewalk is on the road and the speeds, relative to the vehicle, of other vehicles driving in other lanes on the road.

When a sidewalk is on the road, the processor may control the vehicle to drive in the closest lane to the sidewalk.

Information related to whether a sidewalk is on the road and the speeds, relative to the vehicle, of other vehicles driving in other lanes on the road may be referred to as “ambient information.”

FIG. 17 is a view illustrating an example of performing a method of setting a driving route of an AV according to an embodiment of the present disclosure.

FIG. 17 illustrates an example of performing a method of setting a driving route of a vehicle on a road with a sidewalk, according to the present disclosure.

As shown in FIG. 17, if a vehicle 1710 drives on a two-lane road with a sidewalk 1713, the vehicle may drive in the second lane 1712 closest to the sidewalk.

In other words, if there is a sidewalk on the driving road, the processor of the advertising vehicle may keep the lane closest to the sidewalk set as the driving lane.

By allowing the vehicle to drive in the lane closest to the sidewalk, the advertisement may be provided to advertisees on the sidewalk, who may be relatively easily exposed to the advertisement than to advertisees in the vehicles, and the advertisement may thus be provided efficiently.

Now described is a method of setting a driving lane of a vehicle when the road lacks the sidewalk.

FIGS. 18A through 19B illustrate an example of performing a method of setting a driving route of a vehicle on a road without a sidewalk, according to the present disclosure.

FIGS. 18A and 18B illustrates an example in which a processor of a vehicle sets a driving lane on the road which has straight lanes but no sidewalk.

When the road has no sidewalk but has only straight lanes, the processor may set the center lane between other lanes on both sides thereof, as the driving lane.

FIG. 18A illustrates an example in which a vehicle 1810 drives on a two-lane road with no sidewalk. The vehicle may drive in a first lane 1812 on both sides of which a first lane 1811, which is an opposite (backward) lane, and a second lane 1813, which is a forward lane (in the current driving dynamic range) are positioned.

FIG. 18B illustrates an example in which a vehicle 1820 drives on a three-lane road with no sidewalk. The vehicle may drive in a second lane 1822 on both sides of which a first lane 1821 and a second lane 1823 are positioned.

The above examples may apply when there is only one center lane.

When there is no sidewalk, the vehicle may provide advertisements to other vehicles driving in both lanes by driving in the center lane, thereby enabling efficient advertisement.

FIGS. 19A and 19B illustrate an example in which a processor of a vehicle sets a driving lane on the road which has two or more left-turn lanes but no sidewalk.

If the vehicle makes a left turn on the road which has no sidewalk and a straight lane and two or more left-turn lanes, the processor may set the leftmost one of the left-turn lanes as the driving lane.

FIG. 19A illustrates an example in which a vehicle 1910 drives to make a left turn on a road with two left-turn lanes and two straight lanes.

The processor may control the vehicle to drive in the first lane which is the leftmost one of the two left-turn lanes 1911 and 1912.

When there are two left-turn lanes, the vehicle may take advantage of the driver's tendency to look in the direction the vehicle drives by driving in the leftmost lane. Thus, the vehicle may efficiently provide advertisements to the drivers of vehicles driving in the lane to the right of the leftmost lane.

When there are two or more left-turn lanes but no sidewalk, the first lane is not always set as the driving lane. For example, referring to FIG. 19B, the advertising vehicle may drive in the first lane according to the method described above in connection with FIG. 19A while controlled to change the driving lane depending on the conditions of the ambient lanes. For example, when a plurality of vehicles A1, A2, A3, and A4 park in the first lane, and one vehicle A5 parks at the front of the second lane, the advertising vehicle ADV may shift to, and drive in, the second lane. In this case, the plurality of vehicles A1, A2, A3, and A4 parking in the first lane may be advertisees (or advertisee vehicles) on the left side of the advertising vehicle ADV. Vehicles A6 and A7 parking in the third lane may also be advertisees (or advertisee vehicles) on the right side of the advertising vehicle ADV. In this case, the position of the advertising vehicle and the congestion of vehicles in the ambient lanes, as well as the gaze directions of the drivers of the ambient vehicles, may be taken into account in determining the driving lane of the advertising vehicle as described above in connection with FIG. 19A. According to an embodiment of the present disclosure, the advertising vehicle may be controlled to change the area of advertisement as the congestion of vehicles in the ambient lanes varies after the driving lane is determined. For example, if after the advertising vehicle ADV changes from the first lane to the second lane, other vehicles park behind the advertising vehicle ADV in the example of FIG. 19B, the processor may control a rear display of the advertising vehicle ADV to display advertisements.

When the processor of the advertising vehicle sets a driving route, the speed of a specific lane relative to its adjacent lanes may be considered.

FIGS. 20A and 20B illustrate an example of performing a method of setting a driving route of a vehicle on a road with no sidewalk, according to the present disclosure.

FIG. 20A illustrates an example of setting a driving lane on a road with two or more center lanes and no sidewalk.

In such a case, a processor of a vehicle may set a driving lane based on a specific lane and the speed of the specific lane relative to its adjacent lanes on both sides thereof.

Specifically, if the road has no sidewalk and two or more center lanes, the processor may set the center lane with the lowest speed relative to its adjacent lanes among the two or more center lanes as the driving lane.

The respective relative speeds of the two lanes adjacent to the specific center lane may be calculated as the absolute values of the values resultant from subtracting the respective mean speeds of the two adjacent lanes from the mean speed of the specific center lane. Here, ‘mean speed’ means the mean speed of the vehicles driving in the lane.

The processor may monitor the mean speeds for the driving lane and the other lanes on the road via a camera or sensor equipped in the vehicle and change the driving lane depending on a result of monitoring.

Referring to FIG. 20A, there are two center lanes 2012 and 2013. The processor of the vehicle may set the third lane, which has a lower speed relative to its adjacent lanes, of the lanes 2012 and 2013, as the driving lane. For example, since the second lane 2012 has speeds of 40 km/h and 10 km/h relative to its adjacent lanes, and the third lane 2013 has speeds of 10 km/h and 10 km/h relative to its adjacent lanes, the third lane is set as the driving lane. The processor may set the center lane, which has a lower sum of speeds relative to its adjacent lanes, or its mean, among a plurality of center lanes included in all of the lanes on the road, as the driving lane.

FIG. 20B illustrates an example in which there is no sidewalk on the road where vehicles are driving, and the first lane alone among the opposite (backward) lanes and the first lane alone among the (forward) lanes where the vehicle is currently driving are center lanes.

In such a case, the vehicle may set the driving lane based on the speed of the center line relative to the first lane among the opposite lanes.

Specifically, if the speed of the center lane relative to the first lane among the opposite lanes increases to a predetermined level or more, the vehicle may set the first lane among the forward lanes as the driving lane. A value for changing lanes may be preset or may be varied depending on road contexts.

Referring to FIG. 20B, there is one center lane 2022. The processor may control the vehicle to drive in the center lane 2022 as the driving lane and, if the speed of the current driving lane relative to the first lane 2021 among the opposite lanes increases to a predetermined level or more while the vehicle is driving, the processor may change the driving lane to the second lane 2023.

FIG. 21 is a view illustrating a method of calculating a weight for speeds of a specific lane relative to its adjacent lanes on both sides thereof.

If the absolute values of the relative speeds range from 0 km/h to 10 km/h, the weight is set to 2 and, if the absolute values range from 11 km/h to 40 km/h, the weight is set to 1, and if the absolute values are 41 km/h or more, the weight may be 0.

The operation of setting a driving route of operations of a method of setting a driving route of an AV according to the present disclosure is described below in detail with reference to FIGS. 22 to 24.

The processor of the vehicle may set a driving route based on whether the road has a sidewalk, the relative speeds of all the lanes within a specific segment, the degree of congestion of the specific segment, or the number of pedestrians (e.g., advertisees) on the sidewalk within the specific segment.

Information related to the relative speeds of all the lanes within the specific segment, the degree of congestion of the specific segment, or the number of pedestrians (e.g., advertisees) on the sidewalk within the specific segment may be provided to the vehicle via the network. Information containing the above-enumerated pieces of information provided via the network is referred to as route setting information.

As long as the vehicle directly arrives at the corresponding segment, the vehicle may not be aware of the route setting information on its own, and the network provides the route setting information.

FIG. 22 is a view illustrating an example of performing a method of setting a driving route of an AV according to an embodiment of the present disclosure.

FIG. 22 illustrates an example in which a processor of a vehicle 2210 sets a driving route on a road with a sidewalk 2220.

When the road where the vehicle is driving has a sidewalk, the processor controls the vehicle to drive in the lane closest to the sidewalk clockwise or counterclockwise on (or around) the sidewalk.

Specifically, in such an environment where the driver's seat of the vehicle 2210 is on the left hand side of the vehicle, the vehicle may drive in the lane closest to the sidewalk clockwise on the sidewalk. Specifically, in such an environment where the driver's seat of the vehicle 2210 is on the right hand side of the vehicle, the vehicle may drive in the lane closest to the sidewalk counterclockwise on the sidewalk.

By driving in such a way, the vehicle may efficiently expose advertisements to advertisees on the sidewalk.

FIG. 23 is a view illustrating an example of performing a method of setting a driving route of an AV according to an embodiment of the present disclosure.

FIG. 23 illustrates an example in which a processor of a vehicle sets a driving route on a road with a sidewalk.

The processor may consider the degree of congestion of a specific segment to set a driving route. To set a driving route considering the degree of congestion, the processor may use route setting information received from a network. The vehicle may drive in the congested segment based on the route setting information.

By driving in such a way, the vehicle may efficiently expose advertisements to advertisees on the sidewalk.

FIG. 24 is a view illustrating an example of performing a method of setting a driving route of an AV according to an embodiment of the present disclosure.

FIG. 24 illustrates an example in which a processor of a vehicle sets a driving route on a road with no sidewalk.

The processor may consider all relative speeds for a specific segment to set a driving route. To set a driving route considering all the relative speeds, the processor may use route setting information received from a network. The processor may control the vehicle to drive in a portion with a lower relative speed in the specific segment based on the route setting information.

By driving in such a way, the vehicle may efficiently expose advertisements to the advertisees in the vehicle.

FIGS. 25A through 25C are views illustrating a method of calculating weights for variables a vehicle considers to set a route.

FIG. 25A illustrates an example method of calculating a weight for a relative speed. If the absolute values of the relative speeds range from 0 km/h to 10 km/h, the weight is set to 2 and, if the absolute values range from 11 km/h to 40 km/h, the weight is set to 1, and if the absolute values are 41 km/h or more, the weight may be 0.

FIG. 25B illustrates an example method of calculating a weight for the degree of congestion depending on the number of pedestrians on the sidewalk. If there are not many pedestrians on the sidewalk so that the sidewalk is not congested, the weight may be set to 0, if the degree of congestion is on average, the weight may be set to 1, and if the sidewalk is congested, the weight may be set to 2.

FIG. 25C illustrates a method of calculating a weight upon traffic congestion. If the road traffic flows well, the weight may be set to 0, if the vehicles slow down on the road, the weight may be set to 1, and if the road traffic is high, the weight may be set to 2.

The operation of setting a driving scheme of operations of a method of setting a driving route of an AV according to the present disclosure is described below in detail with reference to FIGS. 26 and 27.

The vehicle may set a driving scheme based on whether the road has a sidewalk, the degree of road congestion, and whether there are other advertising vehicles.

FIG. 26 is a view illustrating an example of performing a method of setting a driving route of an AV according to an embodiment of the present disclosure.

Referring to FIG. 26, a vehicle 2610 driving in the first lane may temporarily change to the second lane to provide advertisements to a target 1 vehicle 2630 in an adjacent distance and, after providing advertisements to the target 1 vehicle, change back to the first lane to provide advertisements to a target 2 vehicle 2620.

The driving method may apply in all driving contexts regardless of whether there is a sidewalk.

By driving in such a driving scheme, the vehicle may efficiently provide advertisements to more vehicles.

FIGS. 27A and 27B are views illustrating an example of performing a method of setting a driving route of an AV according to an embodiment of the present disclosure.

FIGS. 27A and 27B illustrates an example in which a vehicle sets a driving scheme when there is another advertising vehicle on the road. According to an embodiment, a different driving lane change schedule may be set depending on what portion the advertising vehicle uses to display advertisements. For example, different driving lane selection schemes may apply to a vehicle displaying advertisements via its front surface and another vehicle displaying advertisements via its side surfaces.

FIG. 27A illustrates an example of setting a driving scheme when advertisements are displayed only via side surfaces of a vehicle.

Referring to FIG. 27A, a vehicle 2711 is driving in the first lane, another advertising vehicle 2712 is driving in the second lane, and target vehicles 2713 and 2714 which receive advertisements are driving in the first lane and the third lane, respectively.

The vehicle 2711 driving in the first lane may pass the other advertising vehicle in the next lane, changing to the second lane. Thereafter, the vehicle 2711 may approach all of the target vehicles receiving advertisements to provide advertisements displayed on the side surfaces.

FIG. 27B illustrates an example of setting a driving scheme when advertisements are displayed through the whole area of the vehicle.

Referring to FIG. 27B, a vehicle 2721 is driving in the first lane, another advertising vehicle 2722 is driving in the second lane, and target vehicles 2723 and 2724 which receive advertisements are driving in the first lane and the third lane, respectively.

The vehicle driving in the first lane may pass the other advertising vehicle in the next lane, changing to the second lane. Thereafter, the vehicle may approach all the target vehicles receiving advertisements and then wait for a predetermined time so as to provide advertisements displayed on the side surfaces. Thereafter, to provide advertisements displayed on the back surface, the vehicle may pass the target vehicles and shift to the first lane and then wait for a predetermined time.

Additionally, the vehicle may receive information (route setting information) necessary for setting a route from the network. The route setting information may include per-driving segment road congestion information, information for the number of pedestrians in the driving segment, and per-driving segment relative speed information. The vehicle may also grasp the route setting information by directly arriving at a specific segment and gathering and storing pieces of information for the segment.

Thus, the vehicle may set a driving route based on the route setting information received from the network or the route setting information that the vehicle itself has gathered and stored.

The network may receive pieces of information necessary for generating route setting information from other servers so as to provide the route setting information to the vehicle.

The vehicle may send a request for the route setting information to the network. The request may be transmitted periodically.

As such, the vehicle may grasp, in real-time, the road context for a specific broad segment by receiving the route setting information from the network.

Although such examples have been described above as to control the driving lane of the advertising vehicle depending on whether there is a sidewalk on the road on which the advertising vehicle is driving, embodiments of the disclosure are not limited thereto. For example, the advertising vehicle may set different advertisement displaying schemes depending on the ambient road context.

Prior to describing a method of setting different advertisement displaying schemes depending on the ambient road context, a method of displaying advertisements via displays equipped in the vehicle is described. Advertisement displays may be mounted on at least one of the front, rear, right side, or left side surface of the advertising vehicle.

Advertisements the vehicle provides are displayed on the display equipped in the vehicle. The display may display a single advertisement on its whole screen. The entire screen of the display may be divided into a specific number of sections, and a plurality of advertisements may simultaneously be displayed in the sections.

For example, the entire screen of the display may be split into two sections, e.g., a first section and a second section, and a first advertisement and a second advertisement, respectively, may be displayed in the first section and the second section. However, this is merely an example, and the present disclosure is not limited thereto.

The advertisements displayed on the screen of the display may be changed according to predetermined periods. For example, when the vehicle provides two advertisements, e.g., a first advertisement and a second advertisement, the first advertisement may be displayed on the entire screen of the display and, after a predetermined time, the first advertisement may be changed to the second advertisement on the entire screen of the display. In other words, the display may display advertisements in the order of the first advertisement, the second advertisement, the first advertisement, and the second advertisement in predetermined periods.

The scheme of displaying a plurality of advertisements on one display and the scheme of changing advertisements displayed on the display in predetermined periods may be combined together. In other words, the vehicle may provide four kinds of advertisements (e.g., a first advertisement, a second advertisement, a third advertisement, and a fourth ad), and the display may provide the advertisements in two sections (e.g., a first section and a second section). In such a case, the advertisements may be displayed on the display in the following manner.

The advertising vehicle may properly change advertisement displaying schemes based on ambient information related to the ambient environment of the driving lane in which the vehicle is currently driving. The ambient information includes sidewalk information related to whether a sidewalk is around the current lane, ambient lane relative speed information related to the relative speeds of the ambient lanes of the current lane, and ambient vehicle information related to the ambient vehicles around the current lane.

The advertisement displayed on the display may be changed to another advertisement based on the ambient information in a predetermined period. Specifically, as the absolute value of the relative speed indicated by the ambient lane relative speed information included in the ambient information decreases, the predetermined period may shorten. Displaying advertisements in such a way enables more advertisements to be provided to vehicles with lower relative speeds.

Where the whole screen of the display is divided into a specific number or sections, and a plurality of advertisements are simultaneously displayed in the sections, the number of advertisements may increase as the absolute value of the relative speed indicated by the ambient lane relative speed information decrease. If the relative speed is high, the advertising effect would not be high although more advertisements are provided to the vehicles driving in the adjacent lanes. Thus, it is possible to efficiently provide various advertisements by allowing more advertisements to be displayed on the display when the relative speed is low.

Where the ambient vehicle information included in the ambient information indicates that there are no ambient vehicles around the current lane, the display may refrain from displaying advertisements. By stopping displaying advertisements when there is no vehicle around, the vehicle may save power consumed to display advertisements on the display.

FIG. 28 is a view illustrating an example of performing a method of setting a driving route of an AV according to an embodiment of the present disclosure.

The processor of the advertising vehicle may obtain information related to the advertisee's reaction to the advertisement (S2810). The information related to the advertisee's reaction to the advertisement may be obtained by the methods described above in connection with FIGS. 14 and 15.

The processor may obtain ambient information related to the ambient environment of the current lane where the advertising vehicle is driving (S2820). The ambient environment information may include information for the context of the current driving road. The road context information may include the number of lanes on the road, the degree of congestion of each lane, mean speed information for at least one vehicle in each lane, and relative speed information for the advertising vehicle and the vehicles in the ambient lanes. The road context information may further include information for whether there is a sidewalk.

The road context information may be received from the network or may be received from the ambient vehicles or the infrastructure on the ambient road via V2X communication.

The processor may set priorities for the lanes where the vehicle may drive based on the ambient information (S2830).

The processor may control the advertising vehicle to drive in a driving lane set based on the priorities (S2840).

Setting a driving lane or driving route for the advertising vehicle described above in connection with the foregoing embodiments may be implemented in association with an artificial intelligence (AI) device. For example, if the advertising vehicle obtains ambient context information, an Ai device (or AI processor) associated with the vehicle may perform AI processing to obtain a driving lane or driving route optimal to provide advertisements and may provide the driving lane or driving route to the vehicle.

FIG. 29 is a flowchart illustrating an example of performing a method of setting a driving route of an AV according to an embodiment of the present disclosure.

The processor of the vehicle may control the transceiver to transmit ambient information for the driving vehicle to the AI processor included in the 5G network. The processor may control the transceiver to receive the AI-processed information from the AI processor. The AI-processed information may include at least one of driving lane information, driving route information, information for the time for maintaining an adjacent distance to the optimal target vehicle, target vehicle information varying in real-time, or lane change information for changes in the target vehicle.

The processor may receive, from the 5G network, downlink control information (DCI) used for scheduling transmission of the ambient context information obtained inside or outside the vehicle. The processor may transmit the ambient context information obtained by the vehicle based on the DCI to the network (S2900).

The processor may perform an initial access procedure with the 5G network based on the synchronization signal block (SSB). The ambient context information may be transmitted to the 5G network via the physical uplink shared channel (PUSCH). The demodulation-reference signals (DM-RSs) of the SSB and the PUSCH may be quasi co-located (QCL) for QCL type D

The AI processor of the 5G network may analyze the ambient context information received from the vehicle. The AI processor may apply the received ambient context information to an artificial neural network (ANN) model. The ANN model may include an ANN classifier, and the AI processor may set the road ambient context information as an input value of the ANN classifier (S2910).

The AI processor may analyze the ANN output value (S2920), obtaining driving lane information (or driving route information) (S2930).

The AI processor may transmit the obtained driving lane information (or driving route information) to the vehicle (UE) via the transceiver (S2940). The above-described AI processing may be performed over the 5G network or may also be performed via cooperation with at least one other vehicles around the advertising vehicle in a distributed networking environment.

For example, where the advertising vehicle transmits the road ambient context information to the 5G network, AI processing may be performed using resources of at least one ambient vehicle connected with the 5G network.

For example, the advertising vehicle itself may perform AI processing, thereby determining a driving lane or driving route.

FIG. 30 illustrates an AI System connected with 5G communication network.

Referring to FIG. 30, in the AI system, at least one or more of an AI server 16, robot 11, self-driving vehicle 12, XR device 13, smartphone 14, or home appliance 15 are connected to a cloud network 10. Here, the robot 11, self-driving vehicle 12, XR device 13, smartphone 14, or home appliance 15 to which the AI technology has been applied may be referred to as an AI device (11 to 15).

The cloud network 10 may comprise part of the cloud computing infrastructure or refer to a network existing in the cloud computing infrastructure. Here, the cloud network 10 may be constructed by using the 3G network, 4G or Long Term Evolution (LTE) network, or 5G network.

In other words, individual devices (11 to 16) constituting the AI system may be connected to each other through the cloud network 10. In particular, each individual device (11 to 16) may communicate with each other through the eNB but may communicate directly to each other without relying on the eNB.

The AI server 16 may include a server performing AI processing and a server performing computations on big data.

The AI server 16 may be connected to at least one or more of the robot 11, self-driving vehicle 12, XR device 13, smartphone 14, or home appliance 15, which are AI devices constituting the AI system, through the cloud network 10 and may help at least part of AI processing conducted in the connected AI devices (11 to 15).

At this time, the AI server 16 may teach the artificial neural network according to a machine learning algorithm on behalf of the AI device (11 to 15), directly store the learning model, or transmit the learning model to the AI device (11 to 15).

At this time, the AI server 16 may receive input data from the AI device (11 to 15), infer a result value from the received input data by using the learning model, generate a response or control command based on the inferred result value, and transmit the generated response or control command to the AI device (11 to 15).

Similarly, the AI device (11 to 15) may infer a result value from the input data by employing the learning model directly and generate a response or control command based on the inferred result value.

<AI+Robot>

By employing the AI technology, the robot 11 may be implemented as a guide robot, transport robot, cleaning robot, wearable robot, entertainment robot, pet robot, or unmanned flying robot.

The robot 11 may include a robot control module for controlling its motion, where the robot control module may correspond to a software module or a chip which implements the software module in the form of a hardware device.

The robot 11 may obtain status information of the robot 11, detect (recognize) the surroundings and objects, generate map data, determine a travel path and navigation plan, determine a response to user interaction, or determine motion by using sensor information obtained from various types of sensors.

Here, the robot 11 may use sensor information obtained from at least one or more sensors among lidar, radar, and camera to determine a travel path and navigation plan.

The robot 11 may perform the operations above by using a learning model built on at least one or more artificial neural networks. For example, the robot 11 may recognize the surroundings and objects by using the learning model and determine its motion by using the recognized surroundings or object information. Here, the learning model may be the one trained by the robot 11 itself or trained by an external device such as the AI server 16.

At this time, the robot 11 may perform the operation by generating a result by employing the learning model directly but also perform the operation by transmitting sensor information to an external device such as the AI server 16 and receiving a result generated accordingly.

The robot 11 may determine a travel path and navigation plan by using at least one or more of object information detected from the map data and sensor information or object information obtained from an external device and navigate according to the determined travel path and navigation plan by controlling its locomotion platform.

Map data may include object identification information about various objects disposed in the space in which the robot 11 navigates. For example, the map data may include object identification information about static objects such as wall and doors and movable objects such as a flowerpot and a desk. And the object identification information may include the name, type, distance, location, and so on.

Also, the robot 11 may perform the operation or navigate the space by controlling its locomotion platform based on the control/interaction of the user. At this time, the robot 11 may obtain intention information of the interaction due to the user's motion or voice command and perform an operation by determining a response based on the obtained intention information.

<AI+Autonomous Navigation>

By employing the AI technology, the self-driving vehicle 12 may be implemented as a mobile robot, unmanned ground vehicle, or unmanned aerial vehicle.

The self-driving vehicle 12 may include an autonomous navigation module for controlling its autonomous navigation function, where the autonomous navigation control module may correspond to a software module or a chip which implements the software module in the form of a hardware device. The autonomous navigation control module may be installed inside the self-driving vehicle 12 as a constituting element thereof or may be installed outside the self-driving vehicle 12 as a separate hardware component.

The self-driving vehicle 12 may obtain status information of the self-driving vehicle 12, detect (recognize) the surroundings and objects, generate map data, determine a travel path and navigation plan, or determine motion by using sensor information obtained from various types of sensors.

Like the robot 11, the self-driving vehicle 12 may use sensor information obtained from at least one or more sensors among lidar, radar, and camera to determine a travel path and navigation plan.

In particular, the self-driving vehicle 12 may recognize an occluded area or an area extending over a predetermined distance or objects located across the area by collecting sensor information from external devices or receive recognized information directly from the external devices.

The self-driving vehicle 12 may perform the operations above by using a learning model built on at least one or more artificial neural networks. For example, the self-driving vehicle 12 may recognize the surroundings and objects by using the learning model and determine its navigation route by using the recognized surroundings or object information. Here, the learning model may be the one trained by the self-driving vehicle 12 itself or trained by an external device such as the AI server 16.

At this time, the self-driving vehicle 12 may perform the operation by generating a result by employing the learning model directly but also perform the operation by transmitting sensor information to an external device such as the AI server 16 and receiving a result generated accordingly.

The self-driving vehicle 12 may determine a travel path and navigation plan by using at least one or more of object information detected from the map data and sensor information or object information obtained from an external device and navigate according to the determined travel path and navigation plan by controlling its driving platform.

Map data may include object identification information about various objects disposed in the space (for example, road) in which the self-driving vehicle 12 navigates. For example, the map data may include object identification information about static objects such as streetlights, rocks and buildings and movable objects such as vehicles and pedestrians. And the object identification information may include the name, type, distance, location, and so on.

Also, the self-driving vehicle 12 may perform the operation or navigate the space by controlling its driving platform based on the control/interaction of the user. At this time, the self-driving vehicle 12 may obtain intention information of the interaction due to the user's motion or voice command and perform an operation by determining a response based on the obtained intention information.

<AI+XR>

By employing the AI technology, the XR device 13 may be implemented as a Head-Mounted Display (HMD), Head-Up Display (HUD) installed at the vehicle, TV, mobile phone, smartphone, computer, wearable device, home appliance, digital signage, vehicle, robot with a fixed platform, or mobile robot.

The XR device 13 may obtain information about the surroundings or physical objects by generating position and attribute data about 3D points by analyzing 3D point cloud or image data acquired from various sensors or external devices and output objects in the form of XR objects by rendering the objects for display.

The XR device 13 may perform the operations above by using a learning model built on at least one or more artificial neural networks. For example, the XR device 13 may recognize physical objects from 3D point cloud or image data by using the learning model and provide information corresponding to the recognized physical objects. Here, the learning model may be the one trained by the XR device 13 itself or trained by an external device such as the AI server 16.

At this time, the XR device 13 may perform the operation by generating a result by employing the learning model directly but also perform the operation by transmitting sensor information to an external device such as the AI server 16 and receiving a result generated accordingly.

<AI+Robot+Autonomous Navigation>

By employing the AI and autonomous navigation technologies, the robot 11 may be implemented as a guide robot, transport robot, cleaning robot, wearable robot, entertainment robot, pet robot, or unmanned flying robot.

The robot 11 employing the AI and autonomous navigation technologies may correspond to a robot itself having an autonomous navigation function or a robot 11 interacting with the self-driving vehicle 12.

The robot 11 having the autonomous navigation function may correspond collectively to the devices which may move autonomously along a given path without control of the user or which may move by determining its path autonomously.

The robot 11 and the self-driving vehicle 12 having the autonomous navigation function may use a common sensing method to determine one or more of the travel path or navigation plan. For example, the robot 11 and the self-driving vehicle 12 having the autonomous navigation function may determine one or more of the travel path or navigation plan by using the information sensed through lidar, radar, and camera.

The robot 11 interacting with the self-driving vehicle 12, which exists separately from the self-driving vehicle 12, may be associated with the autonomous navigation function inside or outside the self-driving vehicle 12 or perform an operation associated with the user riding the self-driving vehicle 12.

At this time, the robot 11 interacting with the self-driving vehicle 12 may obtain sensor information in place of the self-driving vehicle 12 and provide the sensed information to the self-driving vehicle 12; or may control or assist the autonomous navigation function of the self-driving vehicle 12 by obtaining sensor information, generating information of the surroundings or object information, and providing the generated information to the self-driving vehicle 12.

Also, the robot 11 interacting with the self-driving vehicle 12 may control the function of the self-driving vehicle 12 by monitoring the user riding the self-driving vehicle 12 or through interaction with the user. For example, if it is determined that the driver is drowsy, the robot 11 may activate the autonomous navigation function of the self-driving vehicle 12 or assist the control of the driving platform of the self-driving vehicle 12. Here, the function of the self-driving vehicle 12 controlled by the robot 12 may include not only the autonomous navigation function but also the navigation system installed inside the self-driving vehicle 12 or the function provided by the audio system of the self-driving vehicle 12.

Also, the robot 11 interacting with the self-driving vehicle 12 may provide information to the self-driving vehicle 12 or assist functions of the self-driving vehicle 12 from the outside of the self-driving vehicle 12. For example, the robot 11 may provide traffic information including traffic sign information to the self-driving vehicle 12 like a smart traffic light or may automatically connect an electric charger to the charging port by interacting with the self-driving vehicle 12 like an automatic electric charger of the electric vehicle.

<AI+Robot+XR>

By employing the AI technology, the robot 11 may be implemented as a guide robot, transport robot, cleaning robot, wearable robot, entertainment robot, pet robot, or unmanned flying robot.

The robot 11 employing the XR technology may correspond to a robot which acts as a control/interaction target in the XR image. In this case, the robot 11 may be distinguished from the XR device 13, both of which may operate in conjunction with each other.

If the robot 11, which acts as a control/interaction target in the XR image, obtains sensor information from the sensors including a camera, the robot 11 or XR device 13 may generate an XR image based on the sensor information, and the XR device 13 may output the generated XR image. And the robot 11 may operate based on the control signal received through the XR device 13 or based on the interaction with the user.

For example, the user may check the XR image corresponding to the viewpoint of the robot 11 associated remotely through an external device such as the XR device 13, modify the navigation path of the robot 11 through interaction, control the operation or navigation of the robot 11, or check the information of nearby objects.

<AI+Autonomous Navigation+XR>

By employing the AI and XR technologies, the self-driving vehicle 12 may be implemented as a mobile robot, unmanned ground vehicle, or unmanned aerial vehicle.

The self-driving vehicle 12 employing the XR technology may correspond to a self-driving vehicle having a means for providing XR images or a self-driving vehicle which acts as a control/interaction target in the XR image. In particular, the self-driving vehicle 12 which acts as a control/interaction target in the XR image may be distinguished from the XR device 13, both of which may operate in conjunction with each other.

The self-driving vehicle 12 having a means for providing XR images may obtain sensor information from sensors including a camera and output XR images generated based on the sensor information obtained. For example, by displaying an XR image through HUD, the self-driving vehicle 12 may provide XR images corresponding to physical objects or image objects to the passenger.

At this time, if an XR object is output on the HUD, at least part of the XR object may be output so as to be overlapped with the physical object at which the passenger gazes. On the other hand, if an XR object is output on a display installed inside the self-driving vehicle 12, at least part of the XR object may be output so as to be overlapped with an image object. For example, the self-driving vehicle 12 may output XR objects corresponding to the objects such as roads, other vehicles, traffic lights, traffic signs, bicycles, pedestrians, and buildings.

If the self-driving vehicle 12, which acts as a control/interaction target in the XR image, obtains sensor information from the sensors including a camera, the self-driving vehicle 12 or XR device 13 may generate an XR image based on the sensor information, and the XR device 13 may output the generated XR image. And the self-driving vehicle 12 may operate based on the control signal received through an external device such as the XR device 13 or based on the interaction with the user.

[Extended Reality Technology]

eXtended Reality (XR) refers to all of Virtual Reality (VR), Augmented Reality (AR), and Mixed Reality (MR). The VR technology provides objects or backgrounds of the real world only in the form of CG images, AR technology provides virtual CG images overlaid on the physical object images, and MR technology employs computer graphics technology to mix and merge virtual objects with the real world.

MR technology is similar to AR technology in a sense that physical objects are displayed together with virtual objects. However, while virtual objects supplement physical objects in the AR, virtual and physical objects co-exist as equivalents in the MR.

The XR technology may be applied to Head-Mounted Display (HMD), Head-Up Display (HUD), mobile phone, tablet PC, laptop computer, desktop computer, TV, digital signage, and so on, where a device employing the XR technology may be called an XR device.

### Embodiments of the Disclosure

Embodiment 1: A method of setting a driving route of an autonomous vehicle (AV) providing an advertisement on a road comprises obtaining information related to an advertisee's reaction to the advertisement; obtaining ambient information related to an ambient environment of a current lane in which the AV is driving; setting an order of priority for lanes in which the AV are drivable depending on the ambient information; and driving the AV in a lane set based on the order of priority.

Embodiment 2: In embodiment 1, the ambient information may include sidewalk information related to whether a sidewalk is around the current lane, ambient lane relative speed information related to the relative speeds of the ambient lanes of the current lane, and ambient vehicle information related to the ambient vehicles around the current lane.

Embodiment 3: In embodiment 2, if there is the sidewalk, a lane adjacent to the sidewalk may be set to have priority and, unless there is the sidewalk, a center lane among all the lanes of the road, where the AV is driving, including the current lane may be set to have priority.

Embodiment 4: In embodiment 3, when there are two or more center lanes, a specific one with a smaller speed relative to its two adjacent lanes among the two or more center lanes may be set as the driving lane based on relative speed information for the driving lane.

Embodiment 5: In embodiment 2, when there is no sidewalk on the road and there are two or more left-turn lanes, a leftmost one of the two or more left-turn lanes may be set to have priority.

Embodiment 6: In embodiment 1, the method may further comprise receiving driving route setting information from a network; and setting a driving route based on the driving route setting information. The driving route setting information may include at least one of per-driving segment road congestion information, pedestrian count information for the number of pedestrians on a sidewalk present in the driving segment, or all-lane relative speed information related to relative speeds of all lanes per driving segment.

Embodiment 7: In embodiment 6, the reaction-related information may include a reaction value indicating a degree of reaction to the advertisee's advertisement. Obtaining the reaction-related information may include determining whether there is the advertisee's gaze at the advertisement by analyzing an image captured by a camera mounted in the AV, determining whether the advertisee makes a specific gesture towards the advertisement, receiving the advertisee's voice input via a microphone equipped in the AV, and determining whether the voice input contains content related to the advertisement.

Embodiment 8: In embodiment 7, setting the driving route may include setting the driving route based on a first weight determined based on the reaction-related information, a second weight determined based on the road congestion information, and a third weight determined based on the pedestrian count information when there is the sidewalk on the road. A pedestrian on the sidewalk present in the driving segment may be an advertisee.

Embodiment 9: In embodiment 8, the first weight may increase as the reaction value increases. The reaction value may be increased by a predetermined value when there is the advertisee's gaze, when there is the specific gesture, or when the voice input contains the advertisement-related content, and the reaction value is maintained when there is not the advertisee's gaze, there is not the specific gesture, or when the voice input does not contain the advertisement-related content.

Embodiment 10: In embodiment 8, the second weight may increase as the degree of congestion increases.

Embodiment 11: In embodiment 8, the third weight may increase as the number of advertisees increases.

Embodiment 12: In embodiment 6, the method may include setting the driving route based on a first weight determined based on the information related to the advertisee's reaction and a second weight determined based on the all-lane relative speed information when there is no sidewalk.

Embodiment 13: In embodiment 12, the second weight may increase as the absolute value of the relative speed indicated by the all-lane relative speed information decreases.

Embodiment 14: In embodiment 2, the advertisement may be displayed on a display mounted in the AV. The advertisement displayed on the display may be changed to another advertisement in a predetermined period based on ambient information.

Embodiment 15: In embodiment 14, the predetermined period may decrease as an absolute value of a relative speed indicated by the ambient lane relative speed information decreases. The advertisement may not be displayed on the display when the ambient vehicle information indicates that there are no ambient vehicles around the current lane.

Embodiment 16: In embodiment 15, the display may be mounted on at least one of a front, back, right-side, or left-side surface of the AV. The display may be split into at least one screen to simultaneously display at least one different advertisement. The number of the at least one different advertisement may increase as the absolute value of the relative speed indicated by the ambient lane relative speed information decreases.

Embodiment 17: In embodiment 1, the method may further include receiving downlink control information (DCI) used for scheduling transmission of the ambient information. The ambient information may be transmitted to the network based on the DCI.

Embodiment 18: In embodiment 17, the method may further comprise performing an initial access procedure with the network based on a synchronization signal block (SSB). The ambient information may be transmitted to the network via a physical uplink shared channel (PUSCH). Dedicated demodulation reference signals (DM-RSs) of the SSB and the PUSCH may be quasi co-located (QCL) for QCL type D.

Embodiment 19: In embodiment 17, the method may further comprise controlling a transceiver to transmit the ambient information to an artificial intelligence (AI) processor included in the network and controlling the transceiver to receive AI-processed information from the AI processor. The AI-processed information may include information related to the driving lane.

Embodiment 20: An intelligent computing device controlling an AV may include a wireless transceiver, a sensor, a camera, a processor, and a memory including instructions executable by the processor. The instructions may enable the processor to obtain information related to an advertisee's reaction to an advertisement, obtain ambient information related to an ambient environment of a current lane where the AV is driving, set an order of priority for lanes in which the AV is drivable based on the ambient information, and drive the AV in a driving lane set based on the order of priority.

Embodiment 21: In embodiment 20, the ambient information may include sidewalk information related to whether a sidewalk is around the current lane, ambient lane relative speed information related to the relative speeds of the ambient lanes of the current lane, and ambient vehicle information related to the ambient vehicles around the current lane.

Embodiment 22: In embodiment 21, if there is the sidewalk, a lane adjacent to the sidewalk may be set to have priority and, unless there is the sidewalk, a center lane among all the lanes of the road, where the AV is driving, including the current lane may be set to have priority.

Embodiment 23: In embodiment 22, when there are two or more center lanes, a specific one with a smaller speed relative to its two adjacent lanes among the two or more center lanes may be set as the driving lane based on relative speed information for the driving lane.

Embodiment 24: In embodiment 21, when there is no sidewalk on the road and there are two or more left-turn lanes, a leftmost one of the two or more left-turn lanes may be set to have priority.

Embodiment 25: In embodiment 20, the processor may receive driving route setting information from a network and set a driving route based on the driving route setting information. The driving route setting information may include at least one of per-driving segment road congestion information, pedestrian count information for the number of pedestrians on a sidewalk present in the driving segment, or all-lane relative speed information related to relative speeds of all lanes per driving segment.

Embodiment 26: In embodiment 25, the reaction-related information may include a reaction value indicating a degree of reaction to the advertisee's advertisement. To obtain the reaction-related information, the processor may determine whether there is the advertisee's gaze at the advertisement by analyzing an image captured by a camera mounted in the AV, determine whether the advertisee makes a specific gesture towards the advertisement, receive the advertisee's voice input via a microphone equipped in the AV, and determine whether the voice input contains content related to the advertisement.

Embodiment 27: In embodiment 26, to set the driving route, the processor may set the driving route based on a first weight determined based on the reaction-related information, a second weight determined based on the road congestion information, and a third weight determined based on the pedestrian count information when there is the sidewalk on the road. A pedestrian on the sidewalk present in the driving segment may be an advertisee.

Embodiment 28: In embodiment 27, the first weight may increase as the reaction value increases. The reaction value may be increased by a predetermined value when there is the advertisee's gaze, when there is the specific gesture, or when the voice input contains the advertisement-related content, and the reaction value is maintained when there is not the advertisee's gaze, there is not the specific gesture, or when the voice input does not contain the advertisement-related content.

Embodiment 29: In embodiment 27, the second weight may increase as the degree of congestion increases.

Embodiment 30: In embodiment 27, the third weight may increase as the number of advertisees increases.

Embodiment 31: In embodiment 25, the processor may set the driving route based on a first weight determined based on the information related to the advertisee's reaction and a second weight determined based on the all-lane relative speed information when there is no sidewalk.

Embodiment 32: In embodiment 31, the second weight may increase as the absolute value of the relative speed indicated by the all-lane relative speed information decreases.

Embodiment 33: In embodiment 21, the advertisement may be displayed on a display mounted in the AV. The advertisement displayed on the display may be changed to another advertisement in a predetermined period based on ambient information.

Embodiment 34: In embodiment 33, the predetermined period may decrease as an absolute value of a relative speed indicated by the ambient lane relative speed information decreases. The advertisement may not be displayed on the display when the ambient vehicle information indicates that there are no ambient vehicles around the current lane.

Embodiment 35: In embodiment 34, the display may be mounted on at least one of a front, back, right-side, or left-side surface of the AV. The display may be split into at least one screen to simultaneously display at least one different advertisement. The number of the at least one different advertisement may increase as the absolute value of the relative speed indicated by the ambient lane relative speed information decreases.

Embodiment 36: In embodiment 20, the processor may control the transceiver to receive downlink control information (DCI) used for scheduling transmission of the ambient information. The ambient information may be transmitted to the network based on the DCI.

Embodiment 37: In embodiment 36, the processor may control the transceiver to perform an initial access procedure with the network based on a synchronization signal block (SSB). The ambient information may be transmitted to the network via a physical uplink shared channel (PUSCH). Dedicated demodulation reference signals (DM-RSs) of the SSB and the PUSCH may be quasi co-located (QCL) for QCL type D.

Embodiment 38: In embodiment 36, the processor may control the transceiver to transmit the ambient information to an artificial intelligence (AI) processor included in the network and control the transceiver to receive AI-processed information from the AI processor. The AI-processed information may include information related to the driving lane.

According to the present disclosure, the method of setting a driving route of an AV provides the following effects. According to an embodiment of the present disclosure, it is possible to determine the level of reaction to advertisements of advertisees receiving advertisements so as to enable efficient advertisement. According to an embodiment of the present disclosure, it is possible to set a driving route based on the levels of reaction to advertisements of advertisees receiving advertisements so as to enable efficient advertisement. According to an embodiment of the present disclosure, it is possible to implement a method for setting a driving lane of an adverting-purposed vehicle to enable efficient advertisement. According to an embodiment of the present disclosure, it is possible to set a driving route of an adverting-purposed vehicle to enable efficient advertisement.

According to the present disclosure, an intelligent computing device supporting a method of setting a driving route of an AV provides the following effects. According to an embodiment of the present disclosure, it is possible to determine the level of reaction to advertisements of advertisees receiving advertisements so as to enable efficient advertisement. According to an embodiment of the present disclosure, it is possible to set a driving route based on the levels of reaction to advertisements of advertisees receiving advertisements so as to enable efficient advertisement. According to an embodiment of the present disclosure, it is possible to implement a method for setting a driving lane of an adverting-purposed vehicle to enable efficient advertisement. According to an embodiment of the present disclosure, it is possible to set a driving route of an adverting-purposed vehicle to enable efficient advertisement.

In the embodiments described above, the components and the features of the present disclosure are combined in a predetermined form. Each component or feature should be considered as an option unless otherwise expressly stated. Each component or feature may be implemented not to be associated with other components or features. Further, the embodiment of the present disclosure may be configured by associating some components and/or features. The order of the operations described in the embodiments of the present disclosure may be changed. Some components or features of any embodiment may be included in another embodiment or replaced with the component and the feature corresponding to another embodiment. It is apparent that the claims that are not expressly cited in the claims are combined to form an embodiment or be included in a new claim by an amendment after the application.

The embodiments of the present disclosure may be implemented by hardware, firmware, software, or combinations thereof. In the case of implementation by hardware, according to hardware implementation, the exemplary embodiment described herein may be implemented by using one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and the like.

In the case of implementation by firmware or software, the embodiment of the present disclosure may be implemented in the form of a module, a procedure, a function, and the like to perform the functions or operations described above. A software code may be stored in the memory and executed by the processor. The memory may be positioned inside or outside the processor and may transmit and receive data to/from the processor by already various means.

It is apparent to those skilled in the art that the present disclosure may be embodied in other specific forms without departing from essential characteristics of the present disclosure. Accordingly, the aforementioned detailed description should not be construed as restrictive in all terms and should be exemplarily considered. The scope of the present disclosure should be determined by rational construing of the appended claims and all modifications within an equivalent scope of the present disclosure are included in the scope of the present disclosure.

What is claimed is:

1. A method of setting a driving route of an autonomous vehicle (AV) providing an advertisement on a road, the method comprising:
obtaining information related to an advertisee's reaction to the advertisement;
obtaining road context information for surroundings of a current lane in which the AV is driving;
setting an order of priority for lanes in which the AV are drivable depending on a predetermined reference; and
driving the AV in a lane set based on the order of priority.

2. The method of claim 1, wherein the road context information includes information indicating whether there is a sidewalk, relative speed information for ambient lanes of the current lane, or information for road congestion or vehicles around the current lane.

3. The method of claim 2, wherein when there is a sidewalk, a lane adjacent to the sidewalk is set to have priority.

4. The method of claim 2, wherein when there is no sidewalk, a center lane among all lanes, including the current lane, of the road on which the AV is driving is set to have priority.

5. The method of claim 4, wherein when there are two or more center lanes, a specific one with a smaller speed relative to its two adjacent lanes among the two or more center lanes is set as the driving lane based on relative speed information for the driving lane.

6. The method of claim 2, wherein when there is no sidewalk on the road and there are two or more left-turn lanes, a leftmost one of the two or more left-turn lanes is set to have priority.

7. The method of claim 1, further comprising:
receiving driving route setting information from a network; and
setting a driving route based on the driving route setting information, wherein the driving route setting information includes at least one of per-driving segment road congestion information, pedestrian count information for the number of pedestrians on a sidewalk present in the driving segment, or all-lane relative speed information related to relative speeds of all lanes per driving segment.

8. The method of claim 7, wherein the reaction-related information includes a reaction value indicating a degree of reaction to the advertisee's advertisement, and wherein obtaining the reaction-related information includes determining whether there is the advertisee's gaze at the advertisement by analyzing an image captured by a camera mounted in the AV, determining whether the advertisee makes a specific gesture towards the advertisement, receiving the advertisee's voice input, and determining whether the voice input contains content related to the advertisement.

9. The method of claim 8, wherein setting the driving route includes setting the driving route based on a first weight determined based on the reaction-related information, a second weight determined based on the road congestion information, and a third weight determined based on the pedestrian count information when there is the sidewalk on the road, and wherein a pedestrian on the sidewalk present in the driving segment is an advertisee.

10. The method of claim 9, wherein the first weight increases as the reaction value increases, and wherein the reaction value is increased by a predetermined value when there is the advertisee's gaze, when there is the specific gesture, or when the voice input contains the advertisement-related content, and the reaction value is maintained when there is not the advertisee's gaze, there is not the specific gesture, or when the voice input does not contain the advertisement-related content.

11. The method of claim 9, wherein the second weight increases as a degree of congestion increases.

12. The method of claim 9, wherein the third weight increases as the number of advertisees increases.

13. The method of claim 7, wherein setting the driving route includes setting the driving route based on a first weight determined based on the information related to the advertisee's reaction and a second weight determined based on the all-lane relative speed information when there is no sidewalk.

14. The method of claim 13, wherein the second weight increases as an absolute value of a relative speed indicated by the all-lane relative speed information decreases.

15. The method of claim 2, wherein the advertisement is displayed on a display mounted in the AV, and wherein the advertisement displayed on the display is changed to another advertisement in a predetermined period based on ambient information.

16. The method of claim 15, wherein the predetermined period decreases as an absolute value of a relative speed indicated by the ambient lane relative speed information decreases, and wherein the advertisement is not displayed on the display when the ambient vehicle information indicates that there are no ambient vehicles around the current lane.

17. The method of claim 16, wherein the display is mounted on at least one of a front, back, right-side, or left-side surface of the AV, wherein the display is split into at least one screen to simultaneously display at least one different advertisement, and wherein the number of the at least one different advertisement increases as the absolute value of the relative speed indicated by the ambient lane relative speed information decreases.

18. The method of claim 1, further comprising downlink control information (DCI) used for scheduling transmission of the road context information, wherein the road context information is transmitted to the network based on the DCI.

19. The method of claim 18, further comprising performing an initial access procedure with the network based on a synchronization signal block (SSB), wherein the road context information is transmitted to the network via a physical uplink shared channel (PUSCH), and wherein dedicated demodulation reference signals (DM-RSs) of the SSB and the PUSCH may be quasi co-located (QCL) for QCL type D.

20. The method of claim 18, further comprising:
controlling a transceiver to transmit the road context information to an artificial intelligence (AI) processor included in the network; and
controlling the transceiver to receive AI-processed information from the AI processor, wherein the AI-processed information includes the driving lane information or the driving route information.
